(19) United States
(12) Patent Application Publication
(10) Pub. No.: US 2025/0216538 A1
(43) Pub. Date: Jul. 3, 2025

(54) RADAR APPARATUS AND TRANSMISSION METHOD

(71) Applicant: Panasonic Automotive Systems Co., Ltd., Kanagawa (JP)

(72) Inventor: Takaaki KISHIGAMI, Tokyo (JP)

(21) Appl. No.: 18/975,865

(22) Filed: Dec. 10, 2024

(30) Foreign Application Priority Data
Dec. 28, 2023 (JP) 2023-223110

(51) Int. Cl. G01S 13/34; G01S 7/35; G01S 13/50

(52) U.S. Cl. CPC G01S 13/345; G01S 7/35; G01S 13/50

(57) ABSTRACT

A radar apparatus includes: first radar circuitry, which, in operation, transmits a first transmission signal; and second radar circuitry, which, in operation, transmits a second transmission signal; in which a plurality of transmission periods in which the first transmission signal and the second transmission signal are transmitted include a first transmission period in which a transmission timing for the first transmission signal is later than a transmission timing for the second transmission signal by a defined value, and a second transmission period in which the transmission timing for the second transmission signal is later than the transmission timing for the first transmission signal by the defined value.

### TECHNICAL FIELD

The present disclosure relates to a radar apparatus and a transmission method.

### BACKGROUND ART

Recently, studies have been developed on radar apparatuses that use a radar transmission signal (hereinafter, referred to as “TxSig”) of a short wavelength including a microwave or a millimeter wave that can achieve high resolution. Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

PTL 1

U.S. Patent Application Publication No. 2020/0300965

PTL 2

WO2023/074275

PTL 3

Japanese Patent Application Laid-Open No. 2020-148754

PTL 4

Japanese Patent Application Laid-Open No. 2020-204603

### Non-Patent Literature

NPL 1
J. Li, and P. Stoica, “MIMO Radar with Colocated Antennas,” Signal Processing Magazine, IEEE Vol. 24, Issue: 5, pp. 106-114, 2007 NPL 2
E. Fishler, A. Haimovich, R. Blum, D. Chizhik, L. Cimini and R. Valenzuela, “MIMO radar: an idea whose time has come,” Proceedings of the 2004 IEEE Radar Conference, 2004, pp. 71-78

### NPL 3

M. Kronauge, H. Rohling, “Fast two-dimensional CFAR procedure,” IEEE Trans. Aerosp. Electron. Syst., 2013, 49, (3), pp. 1817-1823

### NPL 4

Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### NPL 5

H. Yan, J. Li and G. Liao, “Multitarget Identification and Localization Using Bistatic MIMO Radar Systems,” EURASIP Journal on Advances In Signal Processing, vol. 2008, Article ID 283483, 8 pages, 2008.

### NPL 6

B. Meinecke and D. Werbunat, Q. Haidari and M. Linder, and C. Waldschmidt, “Near-Field Compensation, for Coherent Radar Networks,” IEEE Microwave and Wireless Components Letters, vol. 32, no. 10, pp. 1251-1254.

### SUMMARY OF INVENTION

However, methods for a radar apparatus (e.g., MIMO radar) to sense a target object (or a target) have not been comprehensively studied.

One non-limiting and exemplary embodiment of the present disclosure facilitates providing a radar apparatus and a transmission method capable of efficiently detecting a target object.

A radar apparatus according to an example of the present disclosure includes: first radar circuitry, which, in operation, transmits a first transmission signal; and second radar circuitry, which, in operation, transmits a second transmission signal; in which a plurality of transmission periods in which the first transmission signal and the second transmission signal are transmitted include a first transmission period in which a transmission timing for the first transmission signal is later than a transmission timing for the second transmission signal by a defined value, and a second transmission period in which the transmission timing for the second transmission signal is later than the transmission timing for the first transmission signal by the defined value.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to one exemplary embodiment of the present disclosure, a radar apparatus is capable of efficiently detecting a target object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a radar apparatus having a mono-& multi-static configuration;

FIG. 2 is a block diagram illustrating an exemplary configuration of a radar apparatus;

FIG. 3 is a block diagram illustrating an exemplary configuration of the radar apparatus;

FIG. 4 illustrates an example of a chirp signal;

FIG. 5 illustrates an example of a transmission signal;

FIG. 6 illustrates an example of Doppler multiplexing transmission;

FIG. 7 illustrates an example of Doppler multiplexing transmission;

FIG. 8 illustrates an example of Doppler multiplexing transmission;

FIG. 9 illustrates an example of Doppler multiplexing transmission;

FIG. 10 illustrates an example of Doppler multiplexing transmission;

FIG. 11 illustrates an example of Doppler multiplexing transmission;

FIG. 12 is a block diagram showing an exemplary configuration of a radar apparatus; and

FIG. 13 is a diagram showing an example of the chirp signal.

### DESCRIPTION OF EMBODIMENTS

MIMO radars are roughly divided into, for example, a “monostatic configuration” and a bistatic configuration or a multistatic configuration (hereinafter, referred to as a “bistatic/multistatic configuration”). Hereinafter, the monostatic configuration is referred to as a “MNS configuration,” and the bistatic/multistatic configuration is referred to as a “BMS configuration.”

The MNS configuration may, for example, be a configuration in which a transmitter (for example, including a plurality of transmission antennas and a high-frequency radio) and a receiver (for example, including a plurality of reception antennas and a high-frequency radio) are included in the same housing.

In the BMS configuration, for example, the transmitter and the receiver may be included respectively in different housings. For example, the BMS configuration is a configuration in which the housings are installed at distances apart from each other, and the transmitter and the receiver are connected to a controller that performs synchronization control. In the bistatic configuration, for example, a pair of the transmitter and the receiver is provided, and the transmitter and the receiver are disposed at distances apart from each other. The multistatic configuration is, for example, a configuration in which at least one or both of the transmitter and the receiver are plural. The multistatic configuration is disclosed in, for example, NPL 2.

In the following, a non-limiting exemplary embodiment of the present disclosure focuses on the BMS configuration. For example, in the non-limiting exemplary embodiment, the BMS configuration using a plurality of MIMO radars having the MNS configuration will be described. The BMS configuration using a plurality of MIMO radars having the MNS configuration may be referred to as a “mono-& multi-static configuration,” for example.

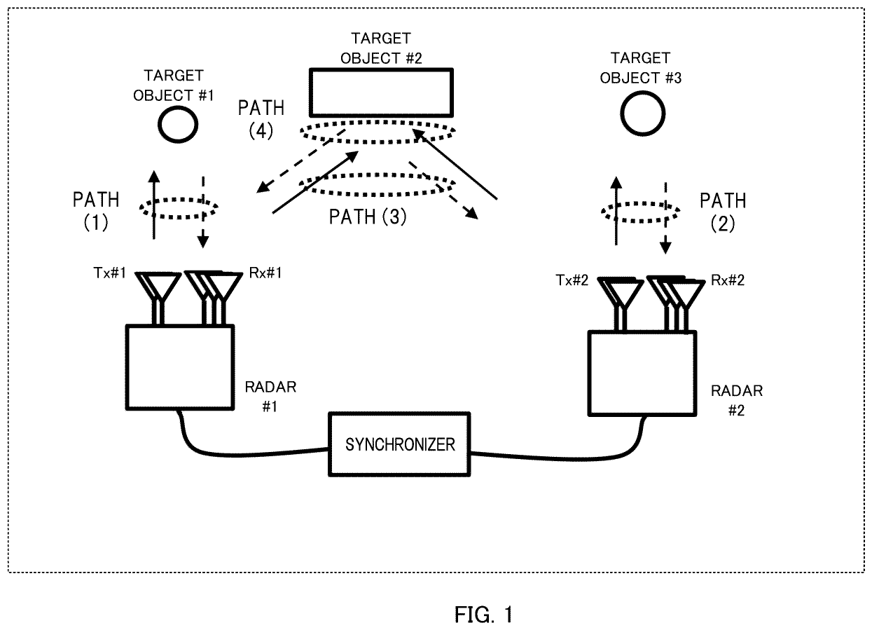

FIG. 1 illustrates an exemplary radar apparatus having the mono-& multi-static configuration in which radar #1 and radar #2 being MIMO radars having the MNS configuration are used.

Radar #1 is, for example, a “first MIMO radar having the MNS configuration” that outputs a radar transmission wave (also referred to as “TxSig”) from radar transmission antenna group Tx #1 and receives a reflected wave signal from target object #1 by radar reception antenna group Rx #1 in the same housing (for example, path (1)).

Similarly, radar #2 is, for example, a “second MIMO radar having the MNS configuration” that outputs a radar transmission wave from radar transmission antenna group Tx #2 and receives a reflected wave signal from target object #3 by radar reception antenna group Rx #2 in the same housing (for example, path (2)).

Further, the radar apparatus illustrated in FIG. 1 may also perform an operation of transmitting a radar transmission wave from transmission antenna group Tx #1 of radar #1 and receiving a reflected wave signal from target object #2 by reception antenna group Rx #2 of radar #2. The radar apparatus performing this operation may be regarded as, for example, a “first MIMO radar having the BMS configuration” (for example, path (3)).

Similarly, the radar apparatus illustrated in FIG. 1 may also perform an operation of transmitting a radar transmission wave from transmission antenna group Tx #2 of radar #2 and receiving a reflected wave signal from target object #2 at the reception antenna group Rx #1 of radar #1. The radar apparatus performing this operation may be regarded as, for example, a “MIMO radar having a second BMS configuration” (for example, path (4)).

For using a radar not only as the radar having the MNS configuration, but also as the radar having the BMS configuration, a synchronizer that performs synchronization control between a plurality of radars having the MNS configuration installed at distant positions may, for example, be used. For example, in FIG. 1, when a Frequency modulated continuous wave (FMCW) signal (for example, a “chirp signal”) is used as the radar transmission wave, the synchronizer may generate the chirp signal and supply a common chirp signal to radar #1 and radar #2. Thus, such a radar can be used as the first MIMO radar having the MNS configuration and the second MIMO radar having the MNS configuration, and can also be used as the first MIMO radar having the BMS configuration and the second MIMO radar having the BMS configuration.

However, it is desirable to use high-quality high-frequency wiring with little attenuation and little transmission distortion of high-frequency signals in a case where a chirp signal that is a high-frequency signal (for example, 60 to 80 GHz band) in a radio frequency band is supplied when the synchronizer supplies the chirp signal to radar #1 and radar #2 in common, and the cost of the entire radar system may thus increase. Therefore, for example, a configuration may be employed in which the chirp signal is individually generated in radar #1 and radar #2, and a synchronizer which outputs a synchronization signal for controlling output timings (or, transmission timings) for the chirp signals may be used.

In this case, the synchronization signal may, for example, be in a frequency band in the MHz order, and the wiring for high-frequency signals in a high-quality radio frequency band does not have to be used. Thus, the cost of the entire radar system can be reduced. In this case, when a MIMO radar with the MNS configuration is utilized, transmission timing errors, frequency errors, or phase errors may be included between chirp signals individually generated in radar #1 and radar #2. Therefore, it is expected that there is a radar configuration preventing deterioration in radar detection performance that occurs due to these errors.

For example, for the transmission by the radars having the BMS configuration using the first and second radars having the MNS configuration, there may be application of multiplexing transmission in which Time Division Multiplexing (TDM), Frequency Division Multiplexing (FDM), or Code Division Multiplexing (CDM) is applied.

Regarding the transmission of the radar having the BMS configuration, for example, PTL 1 or 2 discloses the application of time-division and frequency-division multiplexing transmission, and assumes the following cases.

In the time-division multiplexing transmission in the BMS configuration, for example, the transmission from radar #1 to radar #2 in the BMS configuration is completed, and then the transmission is switched to the transmission from radar #2 to radar #1 in the BMS configuration. Thus, the time required for the transmission processes of both the MNS configuration and the BMS configuration is likely to increase, and the tracking performance during movement of the target is likely to deteriorate.

For example, in FIG. 1, when a frequency modulated continuous wave (FMCW) signal (for example, a “chirp signal”) subjected to frequency modulation is used as the radar transmission wave and transmission between radar #1 and radar #2 is performed in a time-division manner at each transmission period (Tr) of the chirp signal, the following operations are performed.

In first Tr, radar #1 transmits a chirp signal (chirp #1) generated in radar #1 from the transmission antenna, and receives, for example, a signal (target-object reflection wave #1) reflected by target object #1 at the reception antenna of radar #1 as shown in path (1) in FIG. 1. In the reception operation, radar #1 outputs a beat signal according to propagation time TP(1)_{MNS #1} in path (1) by mixing the reception signal of target-object reflection wave #1 and the chirp signal generated in radar #1, and detects target-object distance R(1)_{MNS #1} in the MNS configuration in radar #1 by analyzing the frequency of the beat signal.

During the reception operation of radar #1, radar #2 stops the transmission operation of the chirp signal (or sets the transmission power from the transmission antenna to substantially zero), and receives, for example, a signal (target-object reflection wave #2) being chirp signal (chirp #1) transmitted from radar #1 and reflected by target object #2, with the reception antenna of radar #2 as shown in path (3) in FIG. 1. In the reception operation, radar #2 outputs a beat signal according to propagation time TP(3)_{BMS #2} in path (3) by mixing the reception signal of target-object reflection wave #2 with a chirp signal generated in radar #2, and detects target-object distance R(3)_{BMS #2} in the BMS configuration from radar #1 to radar #2 by analyzing the frequency of the beat signal.

In second Tr, radar #1 and radar #2 perform operations in which the operations of radar #1 and radar #2 in above-described first Tr are swapped. For example, radar #2 transmits a chirp signal (chirp #2) generated by radar #2 from the transmission antenna and performs a reception operation, and thus detects, for example, target-object distance R(2)_{MNS #2} in the MNS configuration according to propagation time TP(2)_{MNS #2} of the signal (target-object reflection wave #3) reflected by target object #3 as shown in path (2) in FIG. 1. During this reception operation of radar #2, radar #1 stops the transmission operation of the chirp signal, performs the reception operation, and detects, for example, target-object distance R(4)_{BMS #1} in the BMS configuration from radar #2 to radar #1 according to propagation time TP(4)_{BMS #1} of target-object reflection wave #2 as shown in path (4) in FIG. 1.

Thereafter, radar #1 and radar #2 perform the same operations as those in first Tr in subsequent odd-numbered Tr, and perform the same operations as those in second Tr in subsequent even-numbered Tr, thereby performing the Doppler frequency analysis of the target object in 2Tr periods for each of the target-object distances detected by the radars to perform Doppler detection on the target object.

The radar apparatus illustrated in FIG. 1 performs Doppler frequency analysis of reflected wave signals every two transmission periods (2Tr) of the chirp signals. Accordingly, a detectable maximum Doppler is likely to decrease, and the range of the Doppler frequency is reduced to ±1/(4Tr). In the following description, the Doppler frequency is also referred to as “DFreq.” Further, the radar apparatus shown in FIG. 1 transmits the radar transmission signals in the time-division manner at every two chirp-signal transmission periods (2Tr), and thus, the number of times of transmitting the radar transmission signals from radar #1 or #2 per required time decreases, possibly resulting in a decrease in the target detection performance (or increase in the measurement time when attempting to maintain the detection performance).

Further, in a case where chirp signal chirp #1 of radar #1 and chirp signal chirp #2 of radar #2 are generated individually respectively in the radars, a deviation (offset) in the transmission timings for the chirp signals, the transmission frequencies, or a phase error may be included.

In this case, due to the offset in the transmission timings or the transmission frequencies, for example, target-object distances R(4)_{BMS #1} and R(3)_{BMS #2} in the above-described BMS configuration, which are offset from each other, are detected, and thus a detected distance error may occur. Note that, in a case where such an offset in the transmission timings or the transmission frequencies is fixed and a variation amount can be ignored, it is possible to correct an error by measuring the offset amount before the radar ranging.

On the other hand, in a case where the offset of the transmission timing or the transmission frequency is subjected to a temperature change or a temporal change and it is difficult to ignore the variation, a detected distance error due to the variation in the offset of the transmission timing or the transmission frequency may occur. In this case, it is expected that the radar apparatus includes a configuration in which the offset amount is detected while performing radar ranging and in which a detected distance error is corrected.

Further, in a case where the phase error varies greatly when chirp signal chirp #1 of radar #1 and chirp signal chirp #2 of radar #2 are generated individually respectively in the radars, the Doppler detection error in the radar apparatus is likely to be increased and there is a possibility that the Doppler detection performance is deteriorated.

Further, for example, when frequency multiplexing transmission in the BMS configuration is performed (for example, the chirp signals are transmitted with such a frequency difference that the frequencies fall outside the reception bands of radar #1 and radar #2), and all the reception antennas of radar #1 or radar #2 perform reception processing for the transmission antennas of the corresponding radar, reception in the first and second BMS configurations is difficult. On the other hand, for example, in a case where a part of the reception antennas of radar #1 or radar #2 performs the reception processing on a transmission signal having a frequency different from the transmission signal of the corresponding radar, the number of reception antennas that receive the reflected wave signal from the transmission signal of the radar decreases. Therefore, in the radar apparatus illustrated in FIG. 1, the reception signal level is likely to be lowered or the angle measurement accuracy is likely to be deteriorated.

In a non-limiting exemplary embodiment of the present disclosure, a method for improving the efficiency of target detection in the mono- & multi-static configuration is described. For example, the non-limiting exemplary embodiment of the present disclosure describes a multiplexing transmission method that maintains radar detection performance (e.g., detectable DFreq range) in the MNS configuration, and enables simultaneous multiplexing transmission not only in the MNS configuration but also in the BMS configuration, to reduce the time required for radar distance measurement.

For example, in a non-limiting exemplary embodiment of the present disclosure, in addition to radar positioning with the MNS configuration of radar #1 and radar #2 illustrated in FIG. 1, radar positioning with the BMS configuration from radar #1 to radar #2 and radar positioning with the BMS configuration from radar #2 to radar #1 may be performed simultaneously.

Further, for example, all the reception antennas of radar #1 or radar #2 may perform reception processing on a transmission signal of the radar.

Note that the radar apparatus according to an exemplary embodiment of the present disclosure may be mounted on a mobile entity such as a vehicle, for example. For example, the radar apparatus may be mounted near at least one of the front or rear corners of a vehicle, or may be mounted near at least one of the front or rear centers of the vehicle or near corners from the centers.

A positioning output (information on an estimation result) of the radar apparatus mounted on a mobile entity may be output to, for example, an Advanced Driver Assistance System (ADAS) that enhances collision safety or a control Electronic Control Unit (ECU) (not illustrated) such as an automated driving system, and may be used for vehicle-drive control or alarm call control.

In addition, the radar apparatus according to one exemplary embodiment of the present disclosure may be attached to a relatively high-altitude structure, such as, for example, a roadside utility pole or traffic lights. Such a radar apparatus can be utilized, for example, as a sensor of a support system for enhancing the safety of passing vehicles or pedestrians, or a suspicious person intrusion prevention system. Further, the positioning output of the radar apparatus may be output to, for example, a control apparatus (not illustrated) in the support system for enhancing the safety or the suspicious person intrusion prevention system, and may be used for alarm call control or abnormality detection control.

The use of the radar apparatus is not limited to the above, and the radar apparatus may also be used for other uses.

Further, the target object is an object to be detected by the radar apparatus, and includes, for example, a vehicle (including four wheels and two wheels), a person, a block, a curbstone, or the like.

Embodiments according to exemplary embodiments of the present disclosure will be described below in detail with reference to the accompanying drawings. In the embodiments, the same constituent elements are identified with the same numerals, and a description thereof is omitted because of redundancy.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Note that, the radar apparatus is not limited to the MIMO radar configuration, and may be, for example, a single input multiple output (SIMO) radar configuration that transmits a transmission signal from one transmission antenna, and the same effects as that in the MIMO radar configuration to be described later can be obtained even in the case of the SIMO radar configuration. In the following description, the case of the SIMO radar configuration is a case where the number (or the number of transmission multiplexing) of transmission antennas is set to 1, and description of parts (for example, the Doppler shift section described later) related to transmission multiplexing in the radar transmitter and parts (for example, the demultiplexer described later) related to demultiplexing of the transmission multiplexing signals in the radar receiver can be omitted.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to transmit a pulse train after performing phase modulation or amplitude modulation on the pulse train.

### EMBODIMENTS

### [Configuration of Radar Apparatus]

The radar apparatus (or radar system) according to the present embodiment may include, for example, a plurality of radar sections (which corresponds to radar circuitry and is, for example, a MIMO radar). Further, the radar apparatus according to the present embodiment may include, for example, a synchronizer that performs synchronization control between a plurality of radar sections, and a positioning output integrator that integrates positioning outputs of the plurality of radar sections.

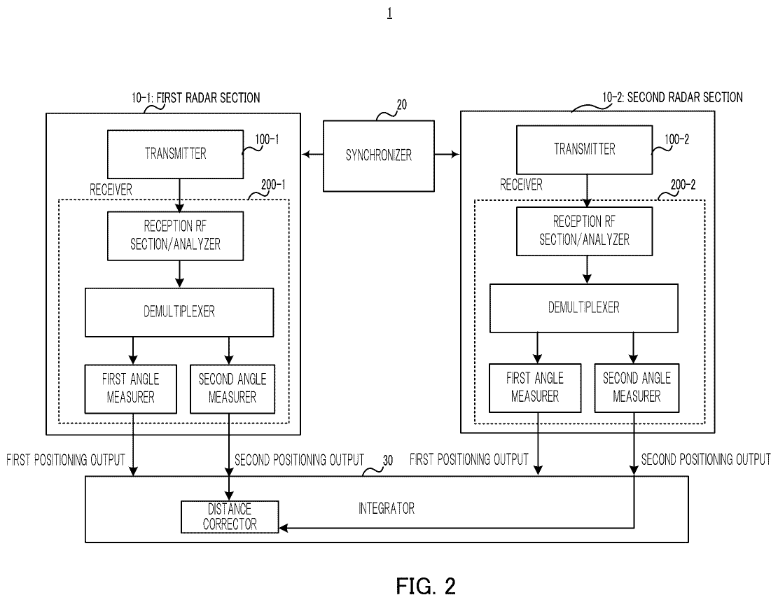

For example, radar apparatus 1 illustrated in FIG. 2 is a radar system including first radar section 10 (or expressed by radar section 10-1) having a plurality of transmission/reception antennas (not illustrated), and second radar section 10 (or expressed by radar section 10-2) having a plurality of transmission/reception antennas (not illustrated).

In radar apparatus 1 illustrated in FIG. 2, synchronizer 20 performs synchronization control between first radar section 10 and second radar section 10. For example, synchronizer 20 may output a reference clock signal (alternately, also referred to as a reference signal) as a synchronization control signal to first radar section 10 and second radar section 10 for synchronization control.

Here, the reference signal is, for example, a high-frequency signal of about several tens to several hundreds MHz. In the case where synchronizer 20 uses the reference signal as the synchronization control signal, a system cost can be reduced as compared with the case where the chirp signal (for example, GHz order) is used. Further, the reference signal of synchronizer 20 may be used as, for example, a reference signal for a voltage controlled oscillator (VCO) that generates a chirp signal.

As described above, in a case where synchronizer 20 uses the reference signal, since the chirp signal is generated individually in each of first radar section 10 and second radar section 10, the phase matching between first radar section 10 and second radar section 10 is not guaranteed, and a phase deviation or a frequency deviation (including an offset in transmission timing) to such an extent as to drift to cause displacement is likely to occur. For example, in order to correct the distance detection error generated by the phase deviation or the frequency deviation between first radar section 10 and second radar section 10, radar apparatus 1 may include, for example, a distance corrector that corrects the detected distances (or the distance detection error) in integrator 30.

For example, radar apparatus 1 may transmit a transmission signal from a plurality of transmission antennas of transmitter 100-1 of first radar section 10. Radar apparatus 1 may perform positioning processing of target object #1, for example, by receiving a reflected wave signal by receiver 200-1 having a plurality of reception antennas of first radar section 10, the reflected wave signal being the transmission signal of first radar section 10 reflected by target object #1 (corresponding to target object #1 in FIG. 1) (for example, radar positioning using the MNS configuration).

Further, radar apparatus 1 may perform positioning processing of target object #2, for example, by receiving a reflected wave signal by receiver 200-2 having a plurality of reception antennas of second radar section 10, the reflected wave signal being the transmission signal of first radar section 10 reflected by target object #2 (corresponding to target object #2 in FIG. 1) (for example, radar positioning using the BMS configuration). Similarly, for example, radar apparatus 1 may transmit a transmission signal from a plurality of transmission antennas of radar transmitter 100-2 of second radar section 10. Radar apparatus 1 may perform positioning processing of target object #3, for example, by receiving a reflected wave signal by receiver 200-2 having a plurality of reception antennas of second radar section 10, the reflected wave signal being the transmission signal of second radar section 10 reflected by target object #3 (corresponding to target object #3 in FIG. 1) (for example, radar positioning using the MNS configuration).

Further, radar apparatus 1 may perform positioning processing of target object #2, for example, by receiving a reflected wave signal by receiver 200-1 having a plurality of reception antennas of first radar section 10, the reflected wave signal being the transmission signal of second radar section 10 reflected by target object #2 (corresponding to target object #2 in FIG. 1) (for example, radar positioning using the BMS configuration).

Note that the reception processing in first radar section 10 and second radar section 10 may be performed using, for example, a MIMO virtual antenna.

In the present embodiment, radar apparatus 1 may perform multiplexing transmission (or simultaneous transmission) of the transmission signal transmitted first radar section 10 and the transmission signal transmitted from second radar section 10.

For example, each of first radar section 10 and second radar section 10 may include a demultiplexer that demultiplexes, from the reception signal, the reflected wave signal corresponding to the transmission signal from transmitter 100 of the corresponding radar section, and also demultiplexes the reflected wave signal corresponding to the transmission signal from transmitter 100 of the other radar section.

Further, for example, each of first radar section 10 and second radar section 10 may include a first angle measurer that measures an angle using the reflected wave signal for the transmission signal from transmitter 100 of the corresponding radar section as demultiplexed by the demultiplexer, and a second angle measurer that measures an angle using the reflected wave signal for the transmission signal from transmitter 100 of the other radar section as demultiplexed by the demultiplexer.

In FIG. 2, for example, integrator 30 may integrate positioning outputs from first radar section 10 (for example, a first and a second positioning outputs) and positioning outputs from second radar section 10 (for example, a first and a second positioning outputs) to perform positioning of the target object. Note that the positioning is information including a direction, a distance, and a Doppler frequency, and may further include demultiplexing index information (which will be described in detail later) of a Doppler multiplexed signal.

Further, integrator 30 may include, for example, a distance corrector that performs correction when distance detection of a reflected wave signal corresponding to a transmission signal from transmitter 100 in another radar section is performed, using an output (for example, the second positioning output of each radar section 10) from a demultiplexer that demultiplexes the reflected wave signal corresponding to the transmission signal from transmitter 100 in another radar section of first radar section 10 and second radar section 10. By the correction by the distance corrector, radar apparatus 1 can perform the distance correction of the reflected wave signal corresponding to a transmission signal from transmitter 100 of another radar section using the output of the distance corrector, and the distance detection accuracy can be improved even in a case where a transmission timing error or a frequency error of the transmission signal or the like is included between first radar section 10 and second radar section 10.

With such a configuration, radar apparatus 1 can receive the reflected wave signal at receiver 200-1 and receiver 200-2, and demultiplex the reception signal depending on whether the received signal is a reflected wave signal for the transmission signal from the corresponding radar section or a reflected wave signal for the transmission signal from the other radar section, so as to appropriately perform the positioning processing based on the positional information of each of first radar section 10 and second radar section 10. Further, since radar apparatus 1 is capable of transmitting a transmission signal from first radar section 10 and second radar section 10 at the same timing, the shortening of the positioning time can also be achieved as compared to the case of the time division multiplexing transmission.

For example, in FIG. 2, first radar section 10 and second radar section 10 may be disposed at locations apart from each other. In this case, radar apparatus 1 can be used as a radar of the so-called BMS configuration. For example, positioning by the radar having the BMS configuration in which the first transmission signal from first radar section 10 is received by radar receiver 200-2 of second radar section 10 and positioning by the radar having the BMS configuration in which the second transmission signal from second radar section 10 is received by radar receiver 200-1 of first radar section 10 are simultaneously possible, and thus it is possible to shorten the positioning time as compared with the case of the time-division multiplexing transmission.

Since first radar section 10 and second radar section 10 illustrated in FIG. 2 have the same configuration, they are collectively denoted and described as “radar sections 10” thereinbelow, and different operations between first radar section 10 and second radar section 10 will be described distinctively.

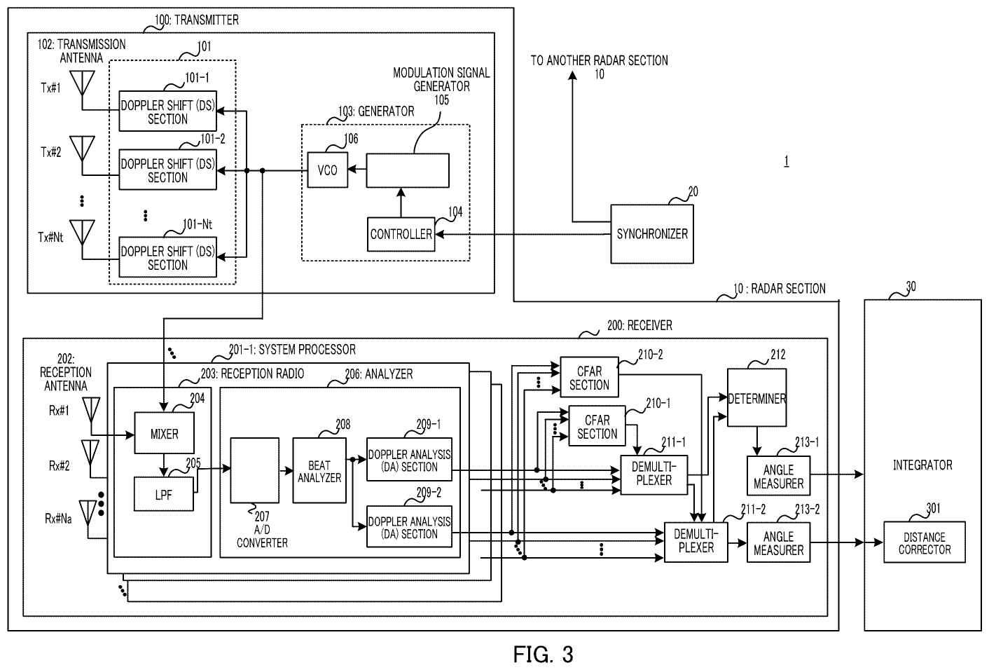

FIG. 3 illustrates an exemplary configuration of radar apparatus 1 in which a frequency-modulated chirp signal is used as a radar transmission wave. Note that, radar apparatus 1 shown in FIG. 3 will be described in relation to a MIMO radar configuration in which Doppler-multiplexed different transmission signals from a plurality of transmission antennas are transmitted and in which each of the transmission signals is demultiplexed in the reception branch and reception processing is performed on the transmission signal, but the present disclosure is not limited thereto, and a similar effect can be obtained even when a code multiplexing transmission from the plurality of transmission antennas is used.

Radar apparatus 1 in FIG. 3 shows an example of first radar section 10-1, synchronizer 20, and integrator 30 in FIG. 2. For example, first radar section 10-1 corresponds to radar section 10. In FIG. 3, an exemplary configuration supported by a radar other than first radar section 10-1 and second radar section 10-2 in FIG. 2 is illustrated, and illustration of other radar section 10 is omitted.

In FIG. 3, synchronizer 20 generates, for example, a synchronization signal and supplies the synchronization signal to a plurality of radar sections 10.

Integrator 30 integrates, for example, the positioning outputs from plurality of radar sections 10 and performs the positioning of a target object. Further, integrator 30 (for example, distance corrector 301 described later) performs correction when distance detection of reflected wave signals corresponding to the transmission signal from another radar section using a second positioning output (for example, the output of angle measurer 213-2 described later) in each of plurality of radar sections 10.

Radar section 10 includes, for example, transmitter (corresponding to a transmission branch or radar transmission circuitry) 100 and receiver (corresponding to a reception branch or radar reception circuitry) 200.

For example, transmitter 100 generates, based on the synchronization signal generated in synchronizer 20, TxSig (for example, a chirp signal), and transmits the generated TxSig at a predetermined transmission period by using a transmission array antenna constituted by a plurality of transmission antennas 102-1 to 102-Nt.

Receiver 200 receives reflected wave signals, which are TxSig reflected by a target object (target)(corresponding to target objects #1 to #3 in FIG. 1), using a reception array antenna composed of a plurality of reception antennas 202-1 to 202-Na, for example. Receiver 200 performs signal processing on the reflected wave signals received at reception antennas 202 to, for example, detect the presence or absence of the target object, or perform positioning of the target object.

### Configuration Example of Transmitter 100

In FIG. 3, transmitter 100 of radar section 10 includes, for example, Doppler shift sections 101-1 to 101-Nt, transmission antennas 102-1 to 102-Nt (for example, Tx #1 to Tx #Nt), and generator 103. Hereinafter, the Doppler shift sections will also be referred to as “DS sections.” Note that, transmission antennas 102 may be connected to respective different DS sections 101. Radar section 10 in FIG. 3 corresponds to first radar section 10, but is hereinafter referred to as qth radar section 10, including second and subsequent radar sections 10. Here, “q” represents indices for identifying a plurality of radar sections 10 included in radar apparatus 1, and may be, for example, q=1 or 2. In the following description, elements included in qth radar section 10 are described with a subindex “−q.”

For example, generator 103 generates TxSig based on the synchronization signal from synchronizer 20. Generated TxSig may be, for example, a predetermined frequency modulated wave (for example, a frequency chirp signal or a chirp signal). Generator 103 outputs the generated chirp signal to DS sections 101.

Generator 103 includes, for example, controller 104, modulation signal generator 105, and VCO 106. Hereinafter, each component in generator 103 will be described.

For example, controller 104 counts a reference signal (clock signal) input as the synchronization signal based on the synchronization signal from synchronizer 20 and outputs a control signal for controlling a transmission timing and a transmission suspension timing for the radar transmission signal to modulation signal generator 105. For the counting of the clock signal, for example, controller 104 may detect the timing of falling or rising edge of the clock signal and may count the number of clock edges.

Modulation signal generator 105 cyclically generates, based on the control signal input from controller 104, a modulation signal in a sawtooth shape, for example. Here, the transmission period of TxSig is set as Tr.

VCO 106 generates a chirp signal based on the modulation signal output from modulation signal generator 105, and outputs the chirp signal to transmitter 100 (for example, DS sections 101-1 to 101-Nt) of radar section 10 and receiver 200 (mixer 204 to be described later).

For example, controller 104 controls the generation of TxSig with respect to modulation signal generator 105 and VCO 106 based on the synchronization signal. For example, controller 104 may configure a parameter (for example, a modulation parameter) related to the chirp signal such that the chirp signal is transmitted Ne times for each transmission period Tr for one radar positioning.

Hereinafter, a case where controller 104 variably configures the transmission timing for a chirp signal in a BMS configuration using a predetermined pattern and repeatedly transmits the chirp signal will be described. Here, a predetermined transmission period in which the transmission timing is repeated in the predetermined pattern will be referred to as “N_{sw}×Tr.” N_{sw} is a predetermined integer value of 2 or more.

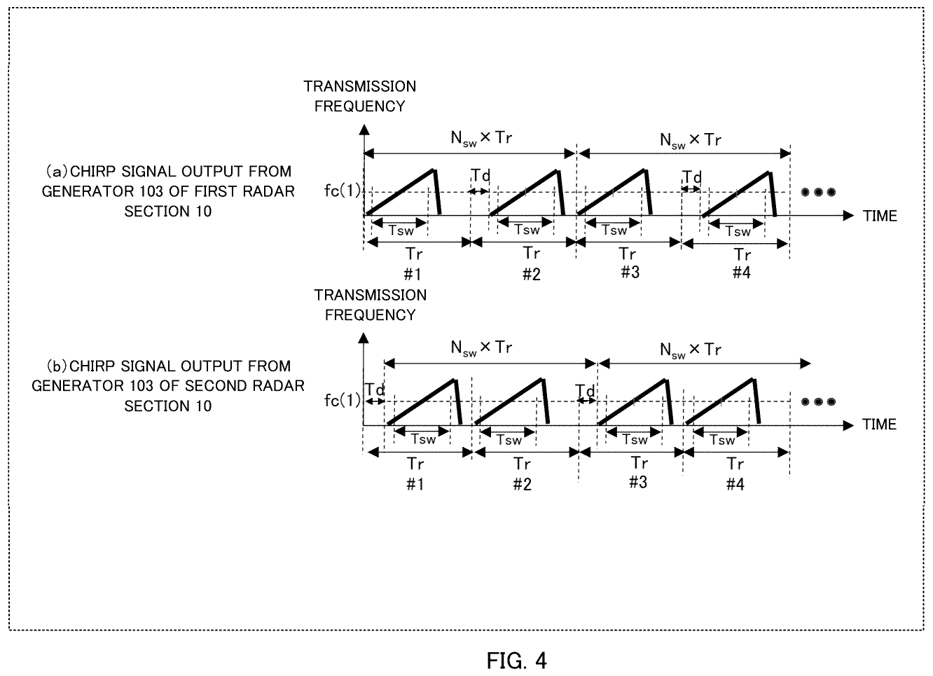

Part (a) in FIG. 4 shows an example of the chirp signal output from generator 103 of first radar section 10, and part (b) in FIG. 4 shows an example of the chirp signal output from generator 103 of second radar section 10. As shown in FIG. 4, the plurality of transmission periods (for example, N_{sw}×Tr periods, where N_{sw}=2 in FIG. 4) includes a transmission period, for example, including predetermined transmission delay Td, and a transmission period not including transmission delay Td, which are repeated at a transmission cycle of 2Tr.

For example, in controller 104, the transmission period including transmission delay Td and the transmission period not including transmission delay Td are configured alternately, and the transmission periods including transmission delay Td are configured not to match between first radar section 10 and second radar section 10. In the example in FIG. 4, in the odd-numbered transmission periods, second radar section 10 includes transmission delay Td and first radar section 10 does not include transmission delay Td, and in the even-numbered transmission periods, second radar section 10 does not include transmission delay

Td and first radar section 10 includes transmission delay Td. As a result, in the example of FIG. 4, in odd-numbered transmission periods, the transmission timing for the chirp signal in second radar section 10 is delayed by transmission delay Td (defined value) compared to the transmission timing for the chirp signal in first radar section 10, and in even-numbered transmission periods, the transmission timing for the chirp signal in first radar section 10 is delayed by transmission delay Td (defined value) compared to the transmission timing for the chirp signal in second radar section 10.

Note that, predetermined transmission delay Td (defined value) is equal to or larger than 0, and may be set within a predetermined range (an example will be described later).

The chirp signal generated by generator 103 is output to DS sections 101 and receiver 200.

For example, radar apparatus 1 can detect a temporal variation of a positioning result of the target object by transmitting, at each transmission period Tr, the chirp signal shown in FIG. 4 and measuring the reflected wave signal in which the chirp signal is reflected in the target, a plurality of times. In the following description, each of the transmission periods among N_{c} transmission periods Tᵣ are represented by the index “m.” Here, m is an integer of from 1 through N_{c}.

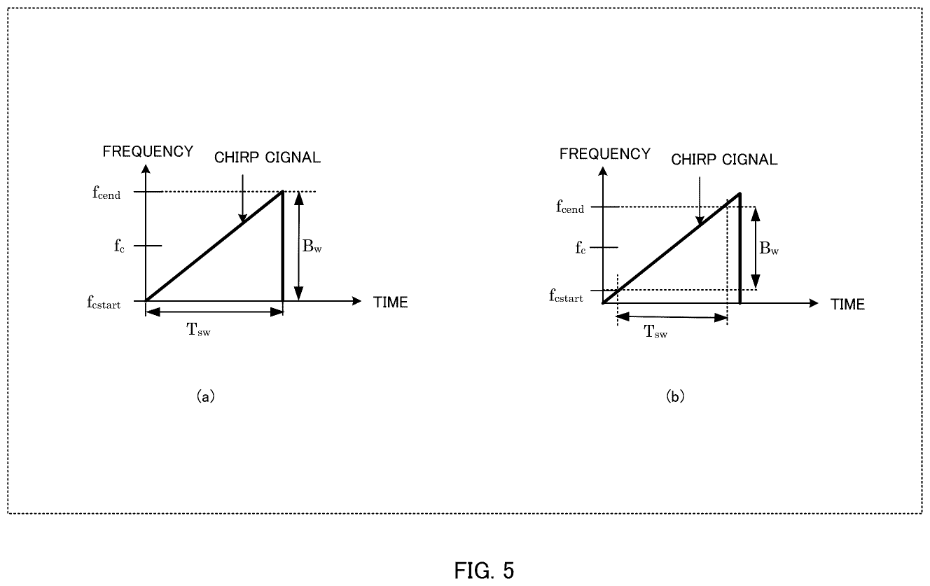

As illustrated in FIG. 5, the modulation parameters for the chirp signal may include, for example, center frequency f_{c}, frequency sweep bandwidth B_{w}, sweep start frequency f_{cstart}, sweep end frequency f_{cend}, frequency sweep duration T_{sw}, and frequency sweep change rate Dₘ. Note that Dₘ=B_{w}/T_{sw}. Note also that B_{w}=f_{cend}−f_{cstart}, and f_{c}=(f_{cstart}+f_{cend})/2.

Frequency sweep time T_{sw} corresponds to, for example, a time range (also called a range gate) in which A/D sampled data is taken by A/D converter 207 of receiver 200, which will be described later. Frequency sweep time T_{sw} may be set to an entire time section of the chirp signal illustrated at (a) in FIG. 5, or to a partial time section of the chirp signal illustrated at (b) in FIG. 5, for example.

Note that FIGS. 4 and 5 illustrate examples of up-chirp waveforms in which the modulation frequency gradually increases with time, but down-chirp may also be applied. The present disclosure can achieve the same effects regardless of whether the waveforms are up-chirp or down-chirp.

Chirp signals output from generator 103 are input to mixers 204 of receiver 200 and Nt DS sections 101, for example.

To apply Doppler shift amount (hereinafter, also referred to as “DS amount”) DOPₙ(q) to the chirp signal inputted from VCO 106 of generator 103, each of DS sections 101 of qth radar section 10 applies phase rotation Φ_{n,q} to the chirp signal for each transmission period Tᵣ of the chirp signal, and outputs the Doppler-shifted signal to transmission antenna 102.

Further, for example, the number of transmission antennas 102 in each qth radar section 10 may be the same or may be different. Hereinafter, the number of transmission antennas in qth radar section 10 will be referred to as “Nt(q)” (or simply “Nt”). Here, Nt (q)≥1. In addition, n=1 to Nt(q).

For example, qth radar section 10 may perform outputs while giving the outpus predetermined phase rotations Φ_{n,q}(m) for applying respective different Doppler shifts to transmission antennas 102 used for the multiplexing transmission in the MNS configuration (an exemplary operation will be described later).

Further, qth radar section 10 may perform outputs while giving the outputs predetermined phase rotation Φ_{n,q}(m) to apply Doppler shifts that provide DS amount patterns different between radar sections 10 that perform multiplexing transmission, for example, in the BMS configuration (an exemplary operation will be described later). For example, the DS amount pattern (or also referred to as a Doppler shift pattern) applied to TxSig transmitted from the plurality of transmission antennas 102 of first radar section 10 may be different from the DS amount pattern in second radar section 10. The DS amount patterns may be configured according to, for example, at least one of a Doppler multiplexing interval (also referred to as “Doppler shift interval” or “Doppler interval,” which is also described as “DDM interval”) and the number of Doppler multiplexing (hereinafter, also referred to as “number of DDM”). Alternatively, qth radar section 10 may perform outputs while giving the outputs predetermined phase rotation Φ_{n,q}(m) to apply Doppler shifts that provide a pattern of DS amounts (e.g., the same DDM interval) the same between radar sections 10 that perform multiplexing transmission, for example, in the BMS configuration (an exemplary operation will be described later).

The output signals outputted from DS sections 101 are amplified to a predetermined transmission power and emitted into space from respective transmission antennas 102 (e.g., Tx #1 to Tx #Nt).

### [Exemplary Configuration of Receiver 200]

In FIG. 3, receiver 200 includes Na reception antennas 202 (for example, Rx #1 to Rx #Na), and serves as a component of an array antenna. Further, receiver 200 includes Na system processors 201, Constant False Alarm Rate (CFAR) sections 210, demultiplexers 211, determiners 212, and angle measurers 213.

Here, the number of reception antennas 202 may be the same or may be different between qth radar sections 10. Hereinafter, the number of reception antennas in qth radar section 10 will be referred to as “Na(q)” (also referred to simply as “Na”). Here, Na(q)≥1.

System processors 201 may be provided to correspond respectively to Na(q) reception antennas 202, for example. In addition, CFAR sections 210, demultiplexers 211, and angle measurers 213 may be provided, for example, in q radar sections 10, respectively.

Each of Na(q) reception antennas 202 receives a reflected wave signal being TxSig transmitted from each of the plurality of radar sections 10 and reflected by a target object (for example, a reflective object including a radar measurement target), and outputs the reflected wave signal to corresponding system processor 201 as a reception signal.

Each of system processors 201 includes reception radio 203 and analyzer 206.

Reception radio 203 includes mixer 204 and low pass filter (LPF) 205. In reception radio 203, mixer 204 mixes the received reflected wave signal (reception signal) with the chirp signal generated in generator 103. Further, a beat signal having a frequency corresponding to a delay time of the reflected wave signal within a passband of LPF 205 is extracted by passing an output of mixer 204 through LPF 205. For example, a difference frequency between a frequency of the transmission signal (transmission frequency-modulated wave) and a frequency of the reception signal (reception frequency-modulated wave) is obtained as the beat frequency (or beat signal) by LPF 205.

Here, a signal falling outside the passband of LPF 205 is attenuated and is not received by receiver 200.

In FIG. 3, analyzer 206 of each system processor 201-z (where z=any one of 1 to Na(q)) includes A/D converter 207, beat analyzer 208, and Doppler analysis section (also referred to as “DA section”) 209.

The signal (for example, beat signal) outputted from LPF 205 is converted into discretely sampled data by A/D converter 207 in analyzer 206.

Beat analyzer 208 performs, for each transmission period Tᵣ, Fast Fourier Transfrom (FFT) processing on N_{data} pieces of discretely sampled data obtained in a predetermined time range (range gate). Here, the range gate may set frequency sweep time T_{sw}. Analyzer 206 thus outputs a frequency spectrum in which a peak appears at a beat frequency dependent on the delay time of the reflected wave signal (radar reflected wave). In the FFT processing, for example, beat analyzer 208 may perform multiplication by a window function coefficient such as the Han window or the Hamming window. The use of the window function coefficient can suppress sidelobes around the beat frequency peak.

Here, a beat frequency response (hereinafter, also referred to as “BF response”) obtained by the mth chirp pulse transmission of the chirp signal, which is outputted from beat analyzer 208 in zth analyzer 206, is denoted as “RFT_{z}(f_{b}, m).” Here, f_{b} denotes the beat frequency index and corresponds to an FFT index (bin number). For example, f_{b}=0 to N_{data}/2−1, z=an integer of from 1 to Na, and m=an integer of from 1 to N_{C}. A beat frequency having smaller beat frequency index f_{b} indicates a shorter delay time of the reflected wave signal (for example, a shorter distance to the target object).

For example, in a case where mixer 204 uses a quadrature mixer that outputs a quadrature component in addition to an in-phase component, negative beat frequency index (bin number) f_{b}=−N_{data}/2 to −1 represents a negative distance. Here, in the reception signal of the radar reflection wave in the MNS configuration, f_{b}=0, . . . , N_{data}/2−1, for example, in which f_{b} does not become a negative distance (f_{b}<0). Accordingly, for example, by configuring transmission delay Td such that the reception signal of the radar reflection wave in the BMS configuration is detected at negative beat frequency index (bin number) f_{b}=−N_{data}/2 to −1, radar apparatus 1 is capable of detecting the reception signal of the radar reflection wave in the BMS configuration which demultiplexing this reception signal from the reception signal of the radar reflection wave in the MNS configuration (hereinafter, also referred to as “distance demultiplexable”).

For example, in a case where the radar reflection wave from the maximum assumed distance in the BMS configuration is referred to as Rmax_{BMS} and the maximum assumed transmission timing error (including a frequency error) is referred to as TEₘₐₓ, transmission delay Td may be set as defined in following Expression 1. Thus, the reception signal of a radar reflection wave in the BMS configuration and the reception signal of a radar reflection wave in the MNS configuration are distance demultiplexable.

$$\begin{matrix}( Expression 1 ) & \\ \frac{{N}_{data}}{2 {B}_{w}} > Td > \frac{R {max}_{BMS}}{{C}_{0}} + {TE}_{max} & [ 1 ]\end{matrix}$$

Here, B_{w} represents a frequency sweep bandwidth within the range gate in the chirp signal.

For example, in a case where TEₘₐₓ or Rmax_{BMS} is relatively large, it is possible to satisfy Expression 1 by the adjustment of decreasing B_{w}. Note that, by adjusting B_{w}, B_{w} may be decreased and the distance resolution may be decreased. In this case, transmissions may be combined, where the transmission in which FDM transmission is performed in first radar section 10 and second radar section 10 by using a chirp signal in which a high distance resolution is obtained and the transmission (for example, the transmission shown in FIG. 4) in which the simultaneous transmission is performed in first radar section 10 and second radar section 10 by using the chirp signal in which B_{w} is set to be small in order to satisfy the transmission delay condition shown in Expression 1 are switched cyclically or adaptively.

Further, in a case where TEₘₐₓ or Rmax_{BMS} is relatively large, it is possible to satisfy Expression 1 by adjustment of increasing N_{data}. Note that, when N_{data} becomes large and chirp transmission period Tr becomes long due to the adjustment of N_{data}, the detectable maximum Doppler frequency may decrease. In this case, transmissions may be combined, where the transmission in which FDM transmission is performed in first radar section 10 and second radar section 10 by using the chirp signal (for example, shortening of transmission period Tr) that increases the maximum Doppler frequency and the transmission (for example, transmission shown in FIG. 4) in which simultaneous transmission is performed in first radar section 10 and second radar section 10 by using the chirp signal in which transmission period Tr (or N_{data}) is set to be large to satisfy the transmission delay condition shown in Expression 1 are switched cyclically or adaptively.

As described above, the transmission period that allows distance demultiplexing is a transmission period in a case where the transmission timing for the chirp signal of another radar section 10 is earlier than the transmission timing for the chirp signal of own radar section 10 (for example, a transmission period in which transmission delay Td is included in the transmission of the chirp signal of own radar section 10). For example, in FIG. 4, in the odd-numbered transmission period, second radar section 10 becomes capable of distance demultiplexing of a reception signal of a radar reflection wave in the MNS configuration and a reception signal of a radar reflection wave from first radar section 10 in the BMS configuration. Meanwhile, in FIG. 4, first radar section 10 becomes capable of detecting reception signals of radar reflection waves in an MNS configuration in odd-numbered transmission periods, and may demultiplex these signals in a case where reception signals of reflection waves from second radar section 10 in a BMS configuration can be mixed by the Td configuration (the exemplary operation will be described later).

Further, for example, in FIG. 4, in the even-numbered transmission periods, first radar section 10 becomes capable of distance demultiplexing of a reception signal of a radar reflection wave in the MNS configuration and a reception signal of a radar reflection wave from second radar section 10 in the BMS configuration. Meanwhile, in FIG. 4, second radar section 10 becomes capable of detecting reception signals of radar reflection waves in the MNS configuration in the even-numbered transmission periods, and in a case where the reception signals of the reflection waves from first radar section 10 in the BMS configuration can be mixed by the Td configuration, these signals may be demultiplexed (an exemplary operation will be described later).

Note that, the configuration of transmission delay Td is not limited to the range of above-described Expression 1, and may be configured as following Expression 2.

$$\begin{matrix}( Expression 2 ) & \\ \frac{{N}_{data}}{2 {B}_{w}} > Td ≧ 0 & [ 2 ]\end{matrix}$$

In this case, the reception signal of the radar reflection wave in the MNS configuration becomes, for example, f_{b}=0, . . . , N_{data}/2−1, and does not become a negative distance (f_{b}<0). Meanwhile, the reception signal of the radar reflection wave in the BMS configuration can be detected not only in a case where the reception signal is detected at a negative index (bin number) f_{b}=−N_{data}/2 to −1, but also at f_{b}=0, . . . , N_{data}/2−1. Such transmission delay Td is also referred to as “half-distance demultiplexable” hereinafter.

In a case where transmission delay Td is set in accordance with the half-distance demultiplexable condition, there is a possibility that, in f_{b}=0, . . . , N_{data}/2−1, the reception signal of a reflection wave at own radar section 10 in the MNS configuration and the reception signal of the reflection wave from another radar sections 10 in the BMS configuration are mixed. For this reason, radar apparatus 1 is expected to demultiplex these signals. For example, in a case where transmission delay Td is set in accordance with the half-distance demultiplexable condition, in the configuration of Doppler multiplexing intervals in DS sections 101 described later, the DDM intervals between plurality of radar sections 10 may be configured to satisfy configuration condition (2). With such a configuration, it is possible to discriminate between a reception signal of own radar reflection wave in an MNS configuration and a reception signal of a reflection wave from another radar in a BMS configuration by utilizing, in below-described CFAR section 210 and demultiplexer 211, the difference in DDM intervals between a plurality of radar sections 10 (exemplary operation will be described later).

Further, beat frequency index f_{b} may be converted into distance information R(f_{b}) by using Expression 3 in a case of MNS configuration, or using Expression 4 in a case of BMS configuration. For this reason, beat frequency index f_{b} will be referred to as “distance index f_{b}” hereinafter (distance index will also be described as “R-Index”).

$$\begin{matrix}( Expression 3 ) & \\ R ( {f}_{b} ) = \frac{{C}_{0} {f}_{b}}{2 {B}_{w}} & [ 3 ]\end{matrix}$$

$$\begin{matrix}( Expression 4 ) & \\ R ( {f}_{b} ) = \frac{{C}_{0} {f}_{b}}{{B}_{w}} & [ 4 ]\end{matrix}$$

Here, B_{w} denotes a frequency sweeping bandwidth within the range gate for a chirp signal, and C₀ denotes the speed of light.

DA sections 209 of zth analyzer 206 perform Doppler analysis for each R-Index by using BF response RFT_{z}(f_{b}, m) obtained by N_{C} chirp pulse transmissions of the chirp signal (e.g., m=1 to N_{C}).

Note that, hereinafter, an exemplary operation of DA sections 209 will be described in a case where application of transmission delay Td is switched alternately for each transmission period Tr between the radars in the BMS configuration as shown in FIG. 4.

The zth DA section 209 performs Doppler analysis for each R-Index by using, from among BF responses RFT_{z}(f_{b}, m) obtained by N_{c} times of chirp pulse transmission, a BF response obtained from the reception signal in the transmission period that allows distance demultiplexing as described above (for example, in the example of FIG. 4, a BF response in a case where m is even in DA sections 209 in first radar section 10 or a BF response in a case where m is odd in DA sections 209 in second radar section 10).

Hereinafter, DA section 209 (in FIG. 3, Doppler analysis section 209-1) that performs Doppler analysis using such a reflected wave signal will be referred to as “first Doppler analysis (DA) section 209” or “mono/multi-demultiplexed reception Doppler analysis (DA) section.”

Further, DA section 209 performs Doppler analysis for each R-Index using the BF response obtained from a reception signal in a transmission period that does not allow distance demultiplexing (for example, in the example in FIG. 4, the BF response in the case of m being an odd number in DA section 209 in first radar section 10 or the BF response in the case of m being an even number in DA section 209 in second radar section 10).

Hereinafter, DA section 209 (in FIG. 3, Doppler analysis section 209-2) that performs Doppler analysis using a reflected wave signal for a transmission period that does not allow distance demultiplexing is also referred to as “second Doppler analysis (DA) section 209” or “Mono/Multi-mixed reception Doppler analysis (DA) section.”

For example, when N_{VFT}=N_{c}/N_{sw} is a power of 2, DA section 209 of qth radar section 10 can apply FFT processing in the Doppler analysis. In this case, the FFT sizes in first DA section 209 (mono/multi-demultiplexed reception DA section) and second DA section 209 (Mono/Multi-mixed reception DA section) are N_{VFT}, and the maximum DFreq at which no aliasing occurs and which is derived from the sampling theorem is #1/(2N_{sw}Tᵣ). Further, the DFreq interval of DFreq index (also referred to as “DF-Index”) fs is 1/(N_{c}×Tᵣ), and the range of fₛ is fₛ=−N_{VFT}/2, . . . , 0, . . . , and N_{VFT}/2−1.

For example, output VFT_{z,q}^{Sep}(f_{b}, fₛ) of the mono/multi-demultiplexed reception DA section from among DA sections 209 in zth analyzer 206 of qth radar section 10 is given by following Expression 5 and output VFT_{z,q}^{Mix}(f_{b}, fₛ) of the Mono/Multi-mixed reception DA section are given by following Expression 6. Here, j is an imaginary unit, z is an integer of from 1 to Na(q), and q is 1 or 2. In addition, the BF response outputted by beat analyzer 208 in qth radar section 10 is expressed as “RFT_{z,q}(f_{b}, m”). The same applies hereinafter. Here, mod (x, y) is a remainder operator, and a remainder obtained by dividing integer x by integer y is outputted. Here, f_{b}=−N_{data}/2, . . . , −1 in the output VFT_{z,q}^{Sep}(f_{b}, fₛ) of the mono/multi-demultiplexed reception DA section is a reflected wave signal according to the BMS configuration, and f_{b}=0, . . . , N_{data}/2−1 outputs the Doppler analysis result of the reflected wave signal according to the MNS configuration.

$$\begin{matrix}( Expression 5 ) & \\ {VFT}_{z , q}^{Sep} ( {f}_{b} , {f}_{s} ) = {\sum }_{s = 0}^{{N}_{VFT} - 1} {RFT}_{z , q} ( {f}_{b} , {N}_{SW} \times s + mod ( q , 2 ) + 1 ) exp [ - \frac{j 2 π {sf}_{s}}{{N}_{VFT}} ] & [ 5 ]\end{matrix}$$

$$\begin{matrix}( Expression 6 ) & \\ {VFT}_{z , q}^{Mix} ( {f}_{b} , {f}_{s} ) = {\sum }_{s = 0}^{{N}_{VFT} - 1} {RFT}_{z , q} ( {f}_{b} , {N}_{SW} \times s + q ) exp [ - \frac{j 2 π {sf}_{s}}{{N}_{VFT}} ] & [ 6 ]\end{matrix}$$

The processing in each component of analyzer 206 has been described above.

In FIG. 3, CFAR sections 210 of qth radar section 10 may include, for example, first CFAR section 210-q (or CFAR section 210-1-q) corresponding to a demultiplexed reception signal in the MNS configuration and BMS configuration at a transmission period that allows distance demultiplexing, and second CFAR section 210-q (or CFAR section 210-2-q) corresponding to a mixed reception signal in the MNS configuration and BMS configuration at a transmission period that does not allow distance demultiplexing.

First CFAR section 210-q performs CFAR processing (for example, adaptive threshold determination) using the outputs from first DA sections 209 (mono/multi-demultiplexed reception DA sections) of first to Na(q)th analyzers 206, and extracts an R-Index and a DF-Index, which give local peak signals. Hereinafter, the R-Index according to the MNS configuration will be referred to as “f_{bp}^{Mono}”, the R-Index according to the BMS configuration will be referred to as “f_{bp}^{BMS}”, the DF-Index according to the MNS configuration will be referred to as “fₛₚ^{Mono}”, and the DF-Index according to the BMS configuration will also be referred to as “fₛₚ^{BMS}”, among local peak signals in a reception signal in the MNS configuration and the BMS configuration, which is subjected to distance demultiplexing and is detected.

Second CFAR section 210-q performs CFAR processing using the outputs from second DA sections (Mono/Multi-mixed reception DA sections) 209 of first to Na(q)th analyzers 206 to extract R-Index (hereinafter, also referred to as f_{bp}^{Mix}) and DF-Index (hereinafter, also referred to as fₛₚ^{Mix}) that provide local peak signals. Note that, fₛₚ^{Mono} fₛₚ^{BMS}, and fₛₚ^{Mix} may include DF-Index for the number of Doppler multiplexing.

For example, first CFAR section 210-q selectively extracts a local reception power peak of a reflected wave signal (a reception signal or a reflected wave signal in the MNS configuration) of TxSig from qth radar section 10 in the MNS configuration, which is subjected to distance demultiplexing with respect to f_{b}=0, . . . , N_{Data}/2−1 by using the output of first DA section 209 in first to Na(q)th analyzers 206. Further, first CFAR section 210-q selectively extracts a local peak of the reflected wave signal of TxSig from qeth radar section 10 in the BMS configuration, which is subjected to distance demultiplexing with respect to f_{b}=−N_{data}/2, . . . , −1 by using the output of first DA section 209 in first to Na(g)th analyzers 206. For example, first CFAR section 210-q may perform, with respect to the Doppler analysis result of the reflected wave signal by the MNS configuration, CFAR processing that performs an adaptive threshold determination after power addition at an interval matching the DDM interval set for the TxSig from qth radar section 10 and may extract f_{bp}^{Mono} and fₛₚ^{Mono} giving a local power peak to output f_{bp}^{Mono} and fₛₚ^{Mono} to first demultiplexer 211. Further, for example, first CFAR section 210-q may perform, with respect to the Doppler analysis results of the reflected wave signals in the BMS configuration, CFAR processing that performs adaptive threshold determination after the power addition at intervals that match the DDM intervals configured for TxSig from qeth radar section 10, then extract f_{bp}^{BMS} and fₛₚ^{BMS} giving a local power peak, and output f_{bp}^{BMS} and fₛₚ^{BMS} to first demultiplexer 211 (an exemplary operation will be described later).

Note that, in a case where transmission delay Td is configured in accordance with the half-distance demultiplexable condition, first CFAR section 210-q performs selective extraction with respect to f_{b}=0, . . . , N_{Data}/2−1 by including the local peaks of the reflected wave signals of TxSig from qeth radar section 10 as the BMS configuration. For example, first CFAR section 210-q may perform, with respect to the Doppler analysis result of the reflected wave signal according to the BMS configuration, CFAR processing that performs the adaptive threshold determination after power addition at intervals matching the DDM intervals configured for TxSig from qeth radar section 10, then extract f_{bp}^{BMS} and fₛₚ^{BMS} giving the local power peaks, and output f_{bp}^{BMS} and fₛₚ^{BMS} to first demultiplexer 211. Further, in a case where the DDM intervals between a plurality of radar sections 10 are set to satisfy the configuration condition (2) described later, first CFAR section 210-q can perform the CFAR processing by utilizing the difference in the DDM intervals between plurality of radar sections 10 to discriminate between a reception signal of an own radar reflection wave in the MNS configuration and a reception signal of a reflection wave from another radar in the BMS configuration.

The transmitter of the MNS configuration in qth radar section 10 is transmitter 100 of qth radar section 10. Similarly, the transmitter of the MNS configuration in qeth radar section 10 is transmitter 100 of first qeth radar section 10. Further, the transmitter in the BMS configuration in qth radar section 10 is transmitter 100 in qeth radar section 10. Similarly, the transmitter in the BMS configuration in qeth radar section 10 is transmitter 100 of qth radar section 10. Note that, qth radar section 10 and qeth radar section 10 are radar sections different from each other, and, for example, in a case where q=1, qe=2, and in a case where q=2, qe=1.

Further, for example, second CFAR section 210-q selectively extracts local reception power peaks of the reflected wave signals (referred to as reception signals or reflected wave signals in the BMS configuration) of TxSig from qeth radar section 10 as the BMS configuration using the outputs of second DA sections 209 of first to Na(q)th analyzers 206.

For example, second CFAR section 210-q may perform the CFAR processing that performs the adaptive threshold determination after the power addition at intervals that match DDM intervals configured for TxSig from qeth radar section 10 different from qth radar section 10, then extract f_{bp}^{Mix} and fₛₚ^{Mix} giving a local power peak, and output f_{bp}^{Mix} and fₛₚ^{Mix} to second demultiplexer 211 (exemplary operation will be described later).

Note that, extracting, by using the outputs of second DA sections 209 in first to Na(q)th analyzers 206, the local reception power peak of the reflected wave signal (hereinafter, referred to as the reflected wave signal in the MNS configuration) of TxSig from qth radar section 10 as the MNS configuration is a result in first CFAR section 210-q, and thus, extraction does not have to be performed in second CFAR section 210-q.

Further, in a case where the DDM intervals configured for TxSig from qeth radar section 10 and the DDM intervals configured for TxSig from qth radar section 10 match each other, a reflected wave signal in the MNS configuration may also be detected. In such a case, for example, in second CFAR section 210-q, extraction is performed by also including f_{bp}^{Mono} and fₛₚ^{Mono} extracted in first CFAR section 210-q (exemplary operation will be described later). On the other hand, in a case where the DDM intervals configured for the TxSig from qeth radar section 10 and the DDM interval or the number of DDM multiplexing configured for TxSig from qth radar section 10 are different from each other, it is possible to prevent a reflection signal in the MNS configuration from being extracted in second CFAR section 210-q by using the inconsistency of the DDM intervals and the numbers of DDM multiplexing described later even in a case where the reflected wave signals in the MNS configuration are mixed.

Further, the transmitter having the BMS configuration in first radar section 10 is transmitter 100 of second radar section 10. Likewise, transmitter 100 having the BMS configuration in second radar section 10 is transmitter 100 of first radar section 10.

Demultiplexers 211 of qth radar section 10 may include first demultiplexer 211-q (also expressed as demultiplexer 211-q-1) that performs Doppler demultiplexing processing (hereinafter, also referred to as “DDM demultiplexing”) using the outputs of first DA section 209 and first CFAR section 210-q, and second demultiplexer 211-q (also referred to as demultiplexer 211-q-2) that performs DDM demultiplexing processing using the outputs of second DA section 209, second CFAR section 210-q, and first demultiplexer 211.

For example, first demultiplexer 211-q of qth radar section 10 performs the DDM demultiplexing on the reflected wave signals (e.g., corresponding to first reflected wave signals) in the MNS configuration and the DDM demultiplexing on the reflected wave signals (e.g., corresponding to second reflected wave signals) in the BMS configuration using the outputs of first CFAR section 210-q. Further, second demultiplexer 211-q of qth radar section 10 performs the DDM demultiplexing on the reflected wave signals (e.g., corresponding to third reflected wave signals) in the MNS configuration and the reflected wave signals (e.g., fourth reflected wave signals) in the BMS configuration using the outputs of first demultiplexer 211-q and the outputs of second CFAR section 210-q.

Further, first demultiplexer 211-q outputs, for example, information on the demultiplexed signals to determiner 212. The output of first demultiplexer 211-q may include, for example, the outputs from first DA sections 209.

Further, for example, second demultiplexer 211-q outputs, to determiner 212, information related to the signal from which the reflected wave signal in the MNS configuration is demultiplexed. Further, for example, second demultiplexer 211-q outputs, to second angle measurer 213-2, information about the signal from which the reflected wave signal in the BMS configuration is demultiplexed. The output of second demultiplexer 211-q may include, for example, the outputs from second DA sections 209.

The information about the demultiplexed signal may include, for example, R-Index and DF-Index corresponding to the separated signal (which may also be referred to as demultiplexing index information below).

The operation of demultiplexer 211-q in qth radar section 10 is related to the operation of DS sections 101 in transmitter 100. Similarly, the operation of CFAR section 210-q is related to the operation of DS sections 101 of transmitter 100.

Hereinafter, an exemplary operation of DS section 101 will be described, and thereafter, exemplary operations of CFAR section 210-q and demultiplexer 211-q will be described.

### [Configuration Method for DS Amount]

To begin with, an example of a configuration method the DS amount applied in DS sections 101 will be described.

First to Nt(q)th DS sections 101 of qth radar section 10 perform Doppler multiplexing transmission (hereinafter, also referred to as “DDM transmission”) by applying respective different DS amounts DOPₙ(q) of predetermined DDM intervals Δfd(q) to the chirp signals inputted from generator 103. At this time, DDM intervals Δfd(q) may satisfy the following configuration condition (1) or (2). Note that, in a case where Nt(q)=1, Doppler shift multiplexing may not be used, and qth radar section 10 may not include DS sections 101. Further, in the case of Nt(q)=1, the DDM interval becomes Δfd(q)=1/(N_{sw}Tᵣ).

### Configuration Condition (1):

The DDM intervals may be set to the same interval between the plurality of radar sections 10. For example, the intervals for respective DS amounts applied to TxSig transmitted from the plurality of transmission antennas 102 of first radar section 10 may be the same as the intervals for respective DS amounts applied to TxSig transmitted from the plurality of transmission antennas 102 of second radar section 10 (for example, Δfd(1)=Δfd(2)).

### Configuration Condition (2):

The DDM intervals between the plurality of radar sections 10 may be set to different intervals. For example, the intervals for respective DS amounts applied to TxSig transmitted from the plurality of transmission antennas 102 of first radar section 10 and the intervals for respective DS amounts applied to TxSig transmitted from the plurality of transmission antennas 102 of second radar section 10 may be different from each other (for example, Δfd(1)≠Δfd(2)).

Hereinafter, a configuration example of DDM interval Δfd(q) will be described.

In the following description, the number of DDM for qth radar section 10 will be referred to as “N_{DM}(q),” and a description is given of a case of N_{DM}(q)=Nt(q), but the present disclosure is not limited thereto. For example, radar section 10 may bundle some of the plurality of transmission antennas 102 to form a transmission beam for performing DDM transmission. Here, N_{DM}(q)<Nt(q) holds true. Further, for example, index n of DS amount DOPₙ(q) represents an index of the DDM signal, and n is an integer of from 1 to N_{DM}(q). Also, N_{DM}(q)≥1 and q=1 or 2. Note that, when Nt(q)=1, Doppler shift multiplexing does not have to be used, and qth radar section 10 does not have to include DS sections 101.

In the present embodiment, controller 104 switches the transmission timing in the BMS configuration cyclically. For this reason, for example, DS sections 101 apply a phase rotation with a predetermined DS amount to a chirp signal at each of the transmission periods (for example, N_{sw}×Tr) of chirp signals in each of transmission timings.

For example, as shown in parts (a) and (b) in FIG. 4, in a case where the transmission period including predetermined transmission delay Td and the transmission period not including transmission delay Td are alternately switched for each transmission period Tr, DS sections 101 set N_{sw}=2 and apply the phase rotation with the predetermined DS amount.

Here, in DA sections 209 (the mono/multi-demultiplexed reception DA section or the Mono/Multi-mixed reception DA section), the range of DFreq fa in which no aliasing is generated and which is derived from the sampling theorem is −1/(2N_{sw}Tᵣ)≤f_{d}<1/(2N_{sw}Tᵣ). For example, when the Doppler frequency exceeds the range of DFreq fa in which no aliasing occurs, DA sections 209 observe an aliasing frequency in the range of −1/(2N_{sw}Tᵣ)≤f_{d}<1/(2N_{sw}Tᵣ). Even when the Doppler shift applied by DS sections 101 is set within a range exceeding −1/(2N_{sw}Tᵣ)≤f_{d}<1/(2N_{sw}Tᵣ), the Doppler shift is equivalent to that set within the range of −1/(2N_{sw}Tᵣ)≤f_{d}<1/(2N_{sw}Tᵣ).

Therefore, for example, when DS sections 101 apply the Doppler shift within the range of −1/(2N_{sw}Tᵣ)≤f_{d}<1/(2N_{sw}Tᵣ), the maximum DDM interval (for example, expressed as “Δfdmax”) for Nt(q) transmission antennas 102 (for example, the number equal to the number of DDM) is Δfdmax=1/(TᵣN_{sw}Nt(q))=1/(TᵣN_{sw}N_{DM}(q)). For example, DS sections 101 may set Δfd(1) and Δfd(2) within the range up to Δfdmax. Accordingly, DS sections 101 can set the Doppler shift within the range of 0 to 2π that is the phase rotation providing the Doppler shift.

For example, the DDM intervals of each of first radar section 10 and second radar section 10 may be set as given by following Expression 7:

$$\begin{matrix}( Expression 7 ) & \\ Δ fd ( q ) = 1 / ( {N}_{sw} {T}_{r} \times ( {N}_{DM} ( q ) + {δ}_{q} ) ) & [ 7 ]\end{matrix}$$

For example, δ_{q} is a parameter that defines the DDM interval. Equations δ₁=δ₂≥0 and N_{DM}(1)=N_{DM}(2) may be set. With this configuration, the DDM interval is the same between the plurality of radar sections 10 (for example, between first radar section 10 and second radar section 10), and satisfies configuration condition (1) (Δfd(1)=Δfd(2)).

Alternatively, δ₁ and δ₂ may be configured such that δ₁, δ₂≥0 and N_{DM}(1)+δ₁≠N_{DM}(2)+δ₂ are satisfied. According to this configuration, the DDM intervals between plurality of radar sections 10 (for example, between first radar section 10 and second radar section 10) are different intervals, and the configuration condition (2) is satisfied (Δfd(1)≠Δfd(2)).

Further, for example, δ₁=δ₂=0 and N_{DM}(1)≠N_{DM}(2) may be set. According to this configuration, the DDM intervals between plurality of radar sections 10 (for example, between first radar section 10 and second radar section 10) are different intervals, and the configuration condition (2) is satisfied (Δfd(1)≠Δfd(2)).

Note that each of δ₁ and δ₂ may be a positive integer or a positive real number. For example, by setting δ₁ and δ₂ to be positive integers, the processes in first CFAR section 210 and second CFAR section 210, which will be described later, can be simplified. Descriptions are given below of a case where δ₁ and δ₂ are each set to zero or a positive integer. However, the present disclosure is not limited thereto, and positive real numbers may be set.

In addition, when supposed situations are mostly those in which radar apparatus 1 and the target object are both stationary, a configuration may be adopted in which parameters (for example, DDM intervals Δfd(q) or δ_{q}) which, for example, cause the DS amounts to match each other between first radar section 10 and second radar section 10 are excluded in advance. For example, for all of n₁ and n₂, the parameters may be set so as to satisfy following Expression 8:

$$\begin{matrix}( Expression 8 ) & \\ {DOP}_{n 1} ( 1 ) \neq {DOP}_{n 2} ( 2 ) , {n}_{1} ∈ \{ 1 , 2 , … Nt ( 1 ) \} , {n}_{2} ∈ \{ 1 , 2 , … Nt ( 2 ) \} & [ 8 ]\end{matrix}$$

By this configuration, for example, DS amount DOPₙ1(1) applied to TxSig of first radar section 10 and DS amount DOPₙ2(2) applied to TxSig of second radar section 10 are set to values different from each other.

For example, when radar apparatus 1 and the target object are both stationary, a Doppler component is zero. Therefore, for example, even when the reflected wave signal of TxSig from first radar section 10 and the reflected wave signal of TxSig from second radar section 10 are included in the same R-Index, DS amount DOPₙ(q) for each MIMO multiplexed transmission signal is set differently, making it possible for radar apparatus 1 to demultiplex and receive both the reflected wave signals by utilizing the difference in detected Doppler components.

Hereinafter, a configuration example of DS amounts will be described.

### Configuration Example 1

Configuration example 1 is a configuration example of a DS amount satisfying configuration condition 1.

For example, in Expression 7 in which q=1, 2 is substituted, configurations that satisfies configuration condition 1 are following condition a and condition b.

Condition a) Case of N_{DM}(1)=N_{DM}(2):

By setting δ₁=δ₂≥0 in Expression 7 in which q=1, 2 is substituted, Δfd(1)=Δfd(2) is obtained. Here, δ₁ and δ₂ may be an integer.

Condition b) Case of N_{DM}(1)≠N_{DM}(2):

By setting q=1, 2 in Expression 7 in which N_{DM}(1)+δ₁=N_{DM}(2)+δ₂, Δfd(1)=Δfd(2) is obtained.

Here, δ₁ and δ₂ may be an integer.

When δ₁=δ₂=0 is set in Expression 7 in which q=1, 2 is substituted, the DDM intervals can be maximized within the range, −1/(2N_{sw}Tᵣ)≤f_{d}<1/(2N_{sw}Tᵣ), of DFreq fa observed in DA sections 209. Therefore, for example, even in a case where the Doppler spectrum has a spread, such as a case where the moving speed of the target is not constant and has a component such as acceleration, the interference effect between the DDM signals can be reduced. Meanwhile, in this case, enlarging observable DFreq by using the non-uniformity of DDM intervals as disclosed in PTL 3 becomes a difficult condition and DFreq falls within −1/(2N_{sw}×Tᵣ×N_{DM}(1))≤f_{d}<1/(2N_{sw}×Tᵣ×N_{DM}(1)). The same applies to the following configuration conditions.

In addition, when δ₁=δ₂>0 is set in Expression 7 in which q=1 and q=2 are substituted, observable DFreq can be enlarged using the non-uniformity of DDM intervals as disclosed in PTL 3, and DFreq of the target object can be detected in the range −1/(2N_{sw}Tᵣ)≤f_{d}<1/(2N_{sw}Tᵣ) of DFreq f_{d} observed in DA sections 209. Further, by applying determiner 212 described later, DFreq of the target object can be detected in the range −1/(2Tr)≤f_{d}<1/(2Tr) of DFreq f_{d} (detailed description will be given later). The same applies to the following configuration conditions.

Hereinafter, an example of DS amounts in configuration example 1 will be described.

### Configuration Example 1-a-1

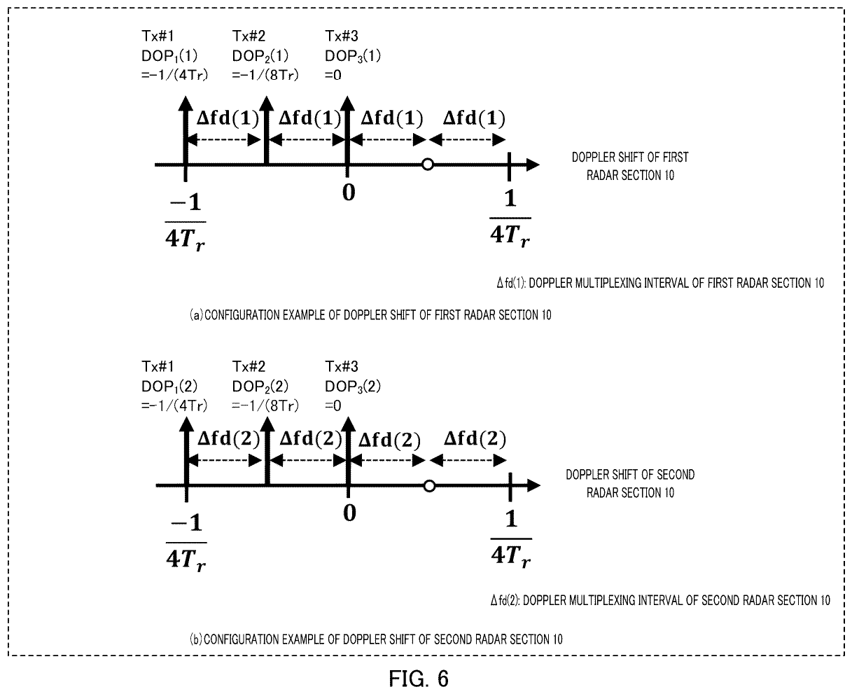

FIG. 6 illustrates, by way of example, a configuration example of the Doppler shifts of first radar section 10 ((a) in the figure) and a configuration example of the Doppler shifts of second radar section 10 ((b) in the figure) in the case where N_{sw}=2, N_{DM}(1)=N_{DM}(2)=3, and δ₁=δ₂=1 and when Δfd(1)=Δfd(2)=1/(8Tr) holds true.

For example, FIG. 6 illustrates DS amounts DOPₙ(q) allocated to transmission antennas 102 (e.g., Tx #1 to Tx #3) of first radar section 10 and second radar section 10. Here, n=1 to 3 and q=1, 2. The DDM intervals, which are Doppler shift intervals assigned to the transmission antennas, are set to an integer multiple of Δfd(1) or Δfd(1).

### Configuration Example 1-a-2

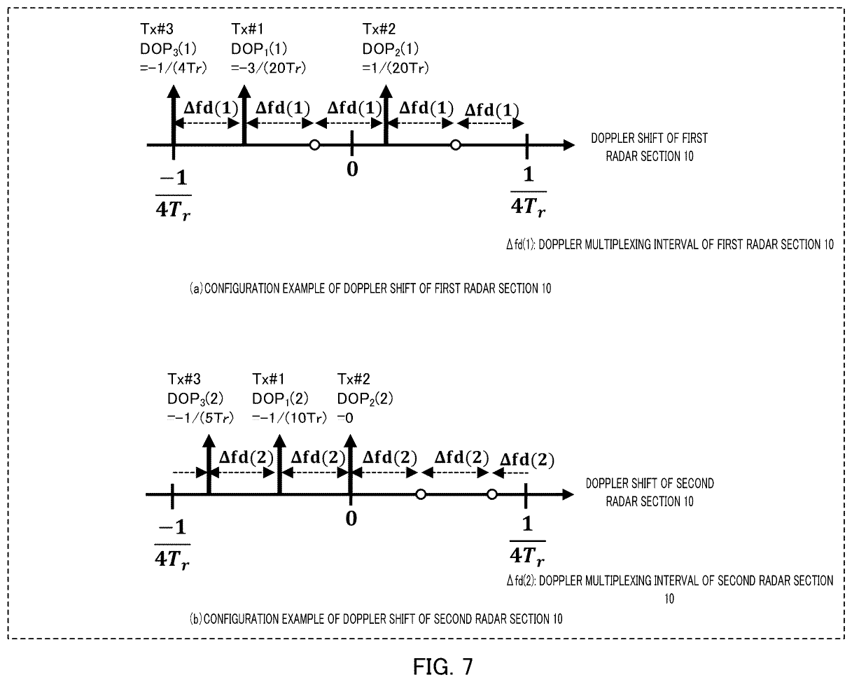

FIG. 7 illustrates, by way of example, a configuration example of the Doppler shifts of first radar section 10 ((a) in the figure) and a configuration example of the Doppler shifts of second radar section 10 ((b) in the figure) in the case where N_{sw}=2, N_{DM}(1)=N_{DM}(2)=3, δ₁=δ₂=2, and Δfd(1)=Δfd(2)=1/(10Tᵣ).

In FIG. 7, DS amounts that do not match each other even with cyclic shifting within a DFreq range of +1/(2N_{sw}×Tᵣ) are used for the configuration of the Doppler shifts of first radar section 10 and second radar section 10. By this configuration, even when a reception signal in the MNS configuration and a reception signal in the BMS configuration are mixed in subsequent demultiplexer 211, the reception signal in the MNS configuration and the reception signal in the BMS configuration can be distinguished from each other, and the demultiplexing performance of radar apparatus 1 can be improved (described later).

Further, in FIG. 7, DS amounts DOPₙ(q) applied to respective transmission antennas 102 of first radar section 10 and second radar section 10 are set so that the DS amounts do not match each other between first radar section 10 and second radar section 10. Here, n=1 to 3 and q=1, 2. The DDM intervals assigned to the transmission antennas are set to integer multiples of Δfd(1) or Δfd(1).

### Configuration Example 1-b

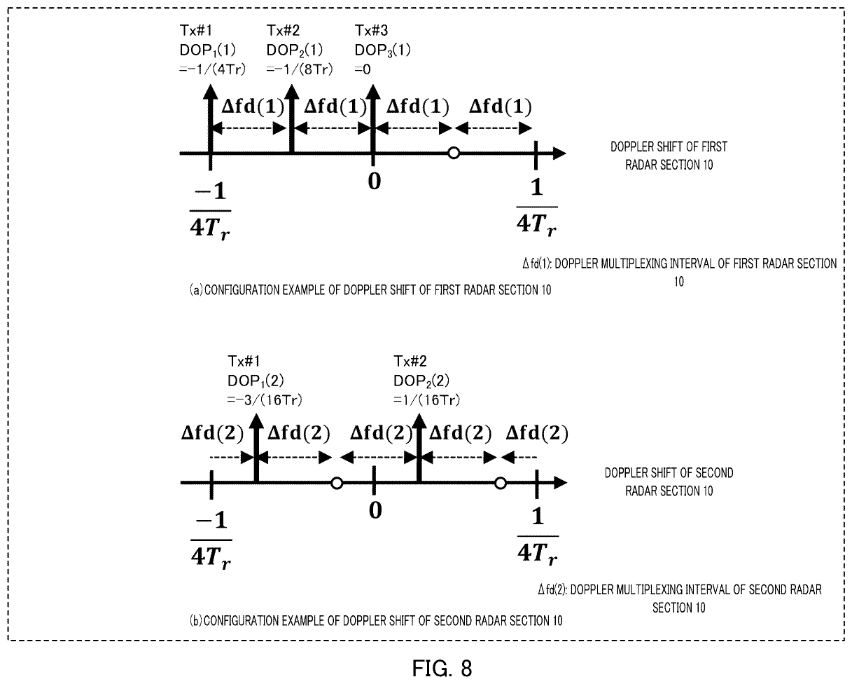

For example, it is possible to set Δfd(1)=Δfd(2)=1/(8Tr) by setting N_{sw}=2, N_{DM}(1)=3, N_{DM}(2)=2, δ₁=1, and δ₂=2. Part (a) in FIG. 8 illustrates a Doppler shift configuration example of first radar section 10, and (b) in FIG. 8 illustrates a Doppler shift configuration example of second radar section 10.

In FIG. 8, DDM intervals assigned to the respective transmission antennas are set to integer multiples of Δfd(1) or Δfd(1). For example, in FIG. 8, in the Doppler shift configurations assigned to the respective transmission antennas of first radar section 10 and second radar section 10, patterns of DS amounts that do not match each other even with cyclic shifting within the DFreq range of ±1/(2N_{sw}×Tr) because of different numbers of DDM (N_{DM}(1)+N_{DM}(2)) are used. By the Doppler shift configuration in FIG. 8, it is possible to improve the demultiplexing performance when the reception signal in the MNS configuration and the reception signal in the BMS configuration are mixed in subsequent demultiplexer 211 (detailed description will be given later).

### Configuration Example 2

Configuration example 2 is a configuration example of DS amounts satisfying configuration condition 2.

For example, in Expression 7 in which q=1, 2 is substituted, a configuration that satisfies above-described configuration condition 2 of DDM interval Δfd(q) is following condition a and condition b.

Condition a) Case of N_{DM}(1)=N_{DM}(2):

By setting δ₁+δ₂>0, Δfd(1)≠Δfd(2) is obtained. Here, δ₁ and δ₂ may be an integer. For example, δ₁≠δ₂ may be set to a positive integer.

Condition b) Case of N_{DM}(1)≠N_{DM}(2):

By setting δ₁=δ₂>0, Δfd(1)≠Δfd(2) is obtained.

Further, a configuration satisfying the following conditions may also be used.

By setting N_{DM}(1)+δ₁≠N_{DM}(2)+δ₂, Δfd(1)≠Δfd(2) is obtained.

Here, δ₁, δ₂ may be an integer. For example, δ₁+δ₂ may be a positive integer. Further, δ₁ and δ₂ may be set such that the DS amounts do not match each other between first radar section 10 and second radar section 10 (for example, so as to satisfy Expression 6).

Hereinafter, the DS amounts in configuration example 2 will be described.

### Configuration Example 2-a

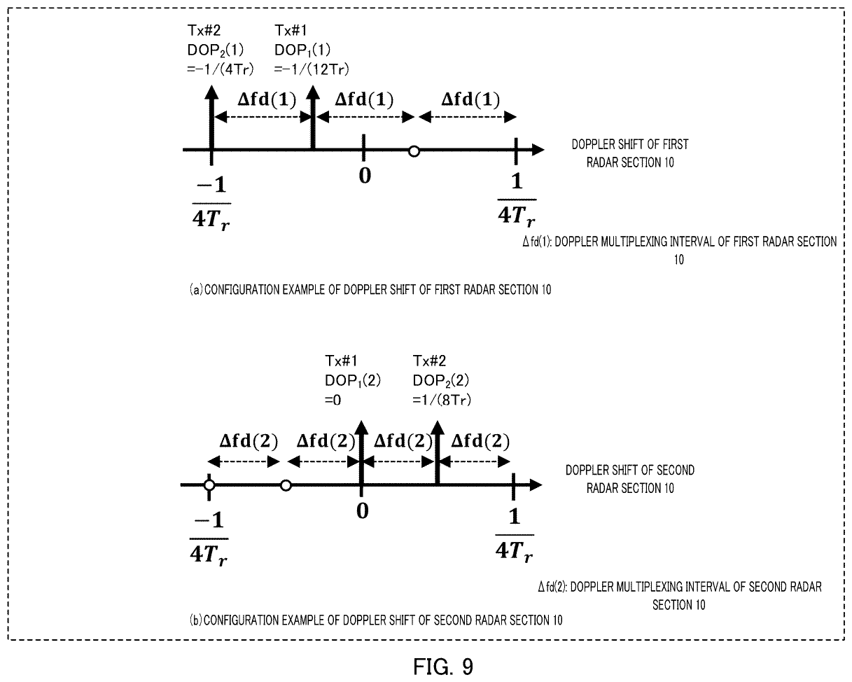

By way of example, FIG. 9 illustrates a configuration example of Doppler shifts of first radar section 10 ((a) in FIG. 9) and a configuration example of Doppler shifts of second radar section 10 ((b) of FIG. 9) in a case of Δfd(1)=1/(6Tr), Δfd(2)=1/(8Tr), N_{sw}=2, N_{DM}(1)=N_{DM}(2)=2, δ₁=1, and δ₂=2.

In the example of FIG. 9, Δfd(1)+Δfd(2) and thus, configuration condition 2 for DDM interval Δfd(q) is satisfied.

### Configuration Example 2-b

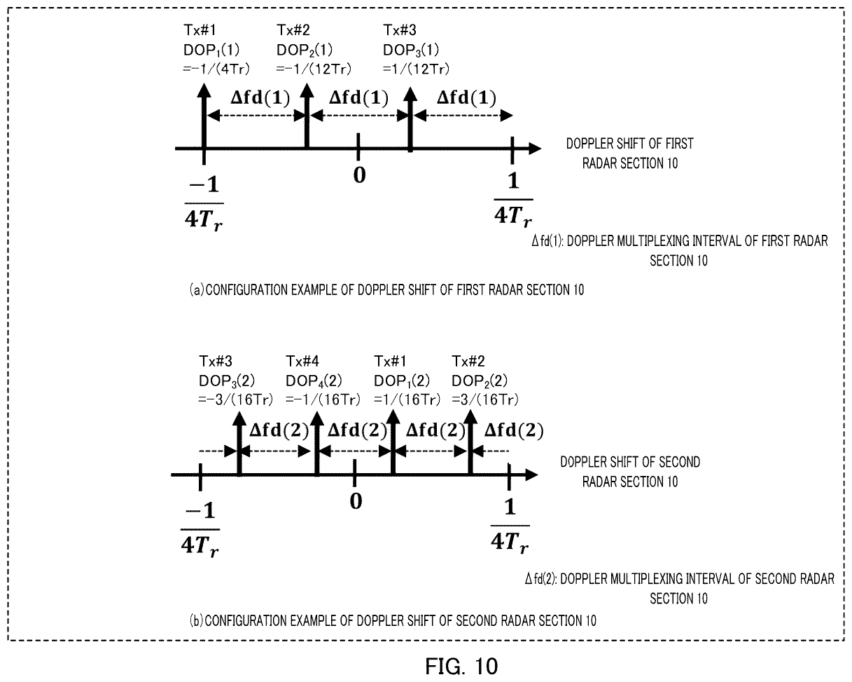

By way of example, FIG. 10 illustrates a configuration example of Doppler shifts of first radar section 10 ((a) in FIG. 10) and a configuration example of Doppler shifts of second radar section 10 ((b) of FIG. 10) in a case of N_{sw}=2, N_{DM}(1)=3, N_{DM}(2)=4, δ₁=δ₂=0.

In the example of FIG. 10, Δfd(1)=1/(6Tr) and Δfd(2)=1/(8Tr) and, thus, configuration condition 2 of DDM intervals Δfd(q) is satisfied.

The configuration examples of DS amounts have been described above.

For example, DS sections 101 may set the DS amounts corresponding to transmission antennas 102 using the DDM intervals set as described above, and apply the phase rotations for applying the DS amounts to the chirp signals at respective chirp transmission periods.

For example, nth DS section 101 of qth radar section 10 applies, to the mth chirp signal as input, phase rotation Φ_{n,q}(m) for applying DS amount DOPₙ(q) different for each nth transmission antenna 102, and outputs the resultant signal. As a result, different Doppler shifts are applied to the transmission signals transmitted respectively from multiple transmission antennas 102.

Here, n is an integer of from 1 to Nt(q), m is an integer of from 1 to N_{c}, and q is 1 or 2.

For example, phase rotations Φ_{n,q}(m) for applying DS amounts DOPₙ(q) for DDM intervals Δfd(q) to TxSig transmitted from Nt(q) (e.g., Nt(q)=N_{DM}(q)) transmission antennas 102 are expressed by following Expression 9. Expression 10 represents DS amounts DOPₙ(q) for DDM intervals Δfd(q).

$$\begin{matrix}( Expression 9 ) & \\ {ϕ}_{n , q} ( m ) = \{ 2 π {N}_{sw} {T}_{r} \times {DOP}_{n} ( q ) + {Δϕ}_{0} \} \times floor [ \frac{m - 1}{{N}_{sw}} ] + {ϕ}_{0} = \{ 2 π {N}_{sw} {T}_{r} \times Δ {f}_{d} ( q ) ( n - α ) + {Δϕ}_{0} \} \times floor [ \frac{m - 1}{{N}_{sw}} ] + {ϕ}_{0} & [ 9 ]\end{matrix}$$

$$\begin{matrix}( Expression 10 ) & \\ {DOP}_{n} ( q ) = Δ {f}_{d} ( q ) ( n - α ) & [ 10 ]\end{matrix}$$

In the expression, PO is the initial phase and APO is a reference Doppler shift phase. Further, a is a coefficient for offsetting the DS amount for each DDM signal and a real value may be used for the coefficient. For example, when α=1, the DS amount for the first DDM signal is zero.

For example, when Nt(1)=Nt(2)=3, ΔΦ0=0, Φ0=0, δ₁=1, and δ₂=2, the DDM intervals are set to Δfd(1)=1/(4N_{sw}Tᵣ) and Δfd(2)=1/(5N_{sw}Tᵣ). Further, for example, when α=1, DS amount DOPₙ(q) corresponding to nth transmission antenna 102 is expressed by following Expression 11:

$$\begin{matrix}( Expression 11 ) & \\ {DOP}_{n} ( q ) = Δ {f}_{d} ( q ) ( n - 1 ) & [ 11 ]\end{matrix}$$

Further, for example, phase rotations Φ_{n,q}(m) for applying DS amounts DOPₙ(q) different for nth (n=1, 2, 3) transmission antennas 102 to the mth chirp signal as input are expressed by following Expression 12:

$$\begin{matrix}( Expression 12 ) & \\ {ϕ}_{1 , 1} ( m ) = 0 , {ϕ}_{2 , 1} ( m ) = \frac{π}{2} floor [ \frac{m - 1}{{N}_{sw}} ] , {ϕ}_{3 , 1} ( m ) = π floor [ \frac{m - 1}{{N}_{sw}} ] , {ϕ}_{1 , 2} ( m ) = 0 , {ϕ}_{2 , 2} ( m ) = \frac{2 π}{5} floor [ \frac{m - 1}{{N}_{sw}} ] , {ϕ}_{3 , 2} ( m ) = \frac{4 π}{5} floor [ \frac{m - 1}{{N}_{sw}} ] & [ 12 ]\end{matrix}$$

For example, when first radar section 10 performs DDM transmission using number Nt of transmission antennas=3, nth DS section 101 in first radar section 10 applies phase rotation Φ_{n,1}(m) to the chirp signal inputted from generator 103 for each transmission period Tᵣ as shown in following Expression 13. The output of nth DS section 101 is output from, for example, nth transmission antenna 102 (Tx #n). Here, cp(t) denotes the chirp signal for each transmission period Here, n=1, . . . , Nt (=3).

$$\begin{matrix}( Expression 13 ) & \\ exp \{ j {ϕ}_{n , 1} ( 1 ) \} cp ( t ) , exp \{ j {ϕ}_{n , 1} ( 2 ) \} cp ( t ) , … , exp \{ j {ϕ}_{n , 1} ( {N}_{c} ) \} cp ( t ) & [ 13 ]\end{matrix}$$

The configuration examples of DS amounts have been described above.

Next, an exemplary operation of first CFAR section 210, second CFAR section 210, first demultiplexer 211, and second demultiplexer 211 in qth radar section 10 corresponding to the operation of DS sections 101 described above will be described.

For example, qth radar section 10 demultiplexes a first reflected wave signal and a second reflected wave signal based on the above-described first reflected wave signal from reception signals in a transmission period in which the reception signals with an MNS configuration and a BMS configuration are distance demultiplexable, and demultiplexes a third reflected wave signal and a fourth reflected wave signal from reception signals in a transmission period in which the reception signal with an MNS configuration and a BMS configuration are not distance demultiplexable.

### [Exemplary Operation of First CFAR Section 210]

For example, first CFAR section 210 of qth radar section 10 may perform the following operation in order to receive a reflected wave signal in a transmission period that allows distance demultiplexing.

For example, first CFAR section 210 may perform peak detection by searching for a power peak matching the DDM intervals configured for TxSig of qth radar section 10 as the MNS configuration in which distance demultiplexing is performed, for each R-Index, where f_{b}=0, . . . , N_{Data}/2−1, with respect to the power addition value of outputs from first DA sections 209 of first to Na(q)th analyzers 206, and by performing adaptive threshold processing (CFAR processing). Similarly, first CFAR section 210 may perform the peak detection by searching for a power peak that matches the DDM intervals configured for TxSig of qeth radar section 10 as a BMS configuration in which distance demultiplexing is performed, for each R-Index where f_{b}=−N_{data}/2, . . . , −1 and by performing adaptive threshold processing (CFAR processing). For example, first CFAR section 210 performs CFAR processing combined with CFAR processing in two dimensions including a distance axis and a DFreq axis (corresponding to a relative velocity) or with one-dimensional CFAR processing in the peak detection (for example, processing disclosed in NPL 3 may be applied).

Here, for example, when DS section 101 sets δ_{q} to a positive integer, the interval of Δfd(q) or the interval of an integer multiple of Δfd(q) is used as the intervals between the DS amounts. In this case, q may be 1 or 2. Therefore, signals on which DDM is performed can be detected as aliasing at an interval of Δfd(q) in the DFreq region of the outputs of first DA section 209. By using such characteristics, for example, the operation of first CFAR section 210 can be simplified as follows.

For example, first CFAR section 210 of qth radar section 10 detects a Doppler peak by applying a threshold to a power addition value obtained by adding together the reception powers of the reflected wave signals for respective ranges (for example, ranges of Δfd(q) or ranges of Δfd(qe)) within the DFreq range that is outputted from first DA sections 209 and subjected to the CFAR processing, the ranges corresponding to the intervals of the DS amounts applied respectively to TxSig.

For example, first CFAR section 210 performs the CFAR processing (hereinafter, also referred to as distance-demultiplexing MNS-configuration CFAR), for each R-Index where f_{b}=0, . . . , N_{data}/2−1, on the outputs from first DA sections 209 of first to Na(g)th analyzers 206 by calculating power addition value PowerDDM_{q}(f_{b}, f_{sdc}) obtained by adding power values Power_{q}FT(f_{b}, fₛ) at the intervals of Δfd(q) (for example, corresponding to N_{Δfd(q)}) as illustrated in following Expressions 14 and 15. Further, first CFAR section 210 performs the CFAR processing (hereinafter, also referred to as distance-demultiplexing BMS-configuration CFAR), for each R-Index where f_{b}=−N_{data}/2, . . . , −1, on the outputs from first DA sections 209 of first to Na(q)th analyzers 206 by calculating power addition value PowerDDM_{q}(f_{b}, f_{sdc}) obtained by adding power values Power_{q}FT(f_{b}, fₛ) at the intervals of Δfd(qe) (for example, corresponding to N_{Δfd(qe)}) as illustrated in following Expression 16. Such CFAR processing is referred to as, for example, “Doppler domain compression CFAR processing,” and is referred to as “DC-CFAR.” DC-CFAR is described in, for example, PTL 4, and detailed explanation thereof is omitted.

$$\begin{matrix}( Expression 14 ) & \\ {PowerDDM}_{q} ( {f}_{b} , {f}_{sdc} ) = {\sum }_{ndm = 1}^{{N}_{DM} ( q ) + {δ}_{q}} {PowerFT}_{q}^{Sep} ( {f}_{b} , {f}_{sdc} + ( ndm - 1 ) \times {N}_{Δ {f}_{d} ( q )} ) & [ 14 ]\end{matrix}$$

$$\begin{matrix}( Expression 15 ) & \\ {PowerFT}_{q}^{Sep} ( {f}_{b} , {f}_{s} ) = {\sum }_{z = 1}^{{N}_{a} ( q )} {\vert {VFT}_{z , q}^{Sep} ( {f}_{b} , {f}_{s} ) \vert}^{2} & [ 15 ]\end{matrix}$$

$$\begin{matrix}( Expression 16 ) & \\ {PowerDDM}_{q} ( {f}_{b} , {f}_{sdc} ) = {\sum }_{ndm = 1}^{{N}_{DM} ( qe ) + {δ}_{qe}} {PowerFT}_{q}^{Sep} ( {f}_{b} , {f}_{sdc} + ( ndm - 1 ) \times {N}_{Δ {f}_{d} ( qe )} ) & [ 16 ]\end{matrix}$$

Here, f_{sdc}=−N_{VFT}/2, . . . , −N_{VFT}/2+N_{Δfd(q)}−1, N_{Δfd(q)}=round(Δfd(q)/(1/(TᵣN_{c})), and N_{Δfd(qe)}=round (Δfd(qe)/(1/(TᵣN_{c})). In addition, round (x) is an operator that rounds off real number x and outputs an integer value.

For example, first CFAR section 210 adaptively sets a threshold by distance-demultiplexing MNS-configuration CFAR, for example, and outputs, to first demultiplexer 211, f_{sdcp}^{Mono} as f_{bp}^{Mono} and fₛₚ^{Mono} at which reception power is greater than the threshold and reception power information (PowerFT_{q}^{Mono}(f_{bp}^{Mono}, f_{sdcp}^{Mono}+(ndm−1)×N_{Δfd(q)})) as the reception signals in the MNS configuration on which distance demultiplexing is performed. Here, ndm is an integer of 1 to N_{DM}(q)+δ_{q}. Further, first CFAR section 210 adaptively sets a threshold by the distance-demultiplexing BMS-configuration CFAR, and outputs, to first demultiplexer 211, f_{sdcp}^{BMS} as f_{bp}^{BMS} and fₛₚ^{BMS} at which reception power is greater than the threshold and reception power information (PowerFT_{q}^{Sep} (f_{bp}^{BMS}, f_{sdcp}^{BMS}+(ndm−1)×N_{Δfd(qe)})) as the reception signals in the BMS configuration on which distance demultiplexing is performed. Here, ndm is an integer of 1 to N_{DM}(qe)+δ_{qe}.

Note that, in a case where transmission delay Td is configured in accordance with the half-distance demultiplexable condition, first CFAR section 210 performs the distance-demultiplexing BMS-configuration CFAR processing with respect to f_{b}=0, . . . , N_{Data}/2−1, in which selective extraction is performed with inclusion of local peaks of reflected wave signals of TxSig from qeth radar section 10 as the BMS configuration, and performs output including f_{sdcp}^{BMS} as fₛₚ^{BMS} and reception power information (PowerFT_{q}^{Sep}(f_{bp}^{BMS}, f_{sdcp}^{mMS}+(ndm−1)×N_{Δfd(qe)})), as a reception signal of the BMS configuration in which distance demultiplexing is performed, to first demultiplexer 211. Further, in a case where the DDM intervals between plurality of radar sections 10 are set to satisfy the configuration condition (2), first CFAR section 210 can perform the CFAR processing by utilizing a difference in the DDM intervals between plurality of radar sections 10, and by discriminating reception signals even in a case where a reception signal of an own radar reflection wave in the MNS configuration and a reception signal of a reflection wave from another radar in the BMS configuration are mixed.

### [Exemplary Operation of First Demultiplexer 211]

First demultiplexer 211 of qth radar section 10 performs DDM demultiplexing of the first reflected wave signal in the MNS configuration and the second reflected wave signal in the BMS configuration using, for example, the outputs (for example, the Doppler frequency components of the reception signals) of first CFAR section 210 and first DA sections 209. For example, first demultiplexer 211 of qth radar section 10 performs the operations of DDM demultiplexing of a reception signal of the MNS configuration described below and DDM demultiplexing of a reception signal of the BMS configuration based on the f_{bp}^{Mono}, f_{sdcp}^{Mono}, f_{bp}^{BMS}, f_{sdcp}^{BMS}, and the reception power information, which are input from first CFAR section 210.

(1) DDM Demultiplexing Processing on MNS Configuration Reception Signals (in Case where δ_{q}>0):

First demultiplexer 211 performs the following processing using the outputs (f_{bp}^{Mono}, f_{sdcp}^{Mono}, and reception power information PowerFT_{q}^{Mono} (f_{bp}^{Mono}, f_{sdcp}^{Mono}+(ndm−1)×N_{Δfd(q)})) of distance-demultiplexing MNS-configuration CFAR of first CFAR section 210.

In first demultiplexer 211, for example, DFreq of the target object may be determined primarily, assuming that DFreq is within −1/(2TᵣN_{sw})≤f_{d}<1/(2TᵣN_{sw}). Since DFreq of the target object is finally determined by subsequent determiner 212, the determination by first demultiplexer 211 is also referred to as “provisional determination” or “provisional decision.” Further, a large difference between, on one hand, the reception levels for top N_{DM}(q) DF-Indices of reception power and, on the other hand, the reception levels for δ_{q} DF-Indices different from the top N_{DM} DF-Indices of reception power (for example, the difference being equal to or greater than the threshold) may be used. For example, first demultiplexer 211 compares the reception power information inputted from first CFAR sections 210 and primarily determines DFreq. Note that an exemplary operation of first demultiplexer 211 is disclosed in, for example, PTL 3, and therefore description of the exemplary operation is omitted here.

For example, first demultiplexer 211 associates the DS amounts of the transmitted DDM signals with f_{sdcp}^{Mono}+(ndm−1)×N_{Δfd(q)} based on the relation between δ_{q} DF-Indices of a lower reception level and top N_{DM}(q) DF-Indices of a higher reception power, and outputs it as DDM-signal demultiplexing index information f_{Tx}(q)=(f_{dmlTx #1}(q), . . . , f_{dmlTx #NDM} (q)) to second demultiplexer 211 and determiner 212.

Here, f_{dmlTx #n} (q) indicates DF-Index of the reflected wave signal of TxSig transmitted from nth transmission antenna 102 (Tx #n) of qth radar section 10. In this way, first demultiplexer 211 regards the outputs of first DA sections 209 corresponding to demultiplexing index information f_{Tx}(q) of the DDM signal in R-Index f_{bp}^{Mono}, as first reflected wave signals, and outputs the outputs of first DA sections 209 to determiner 212 along with the R-Index information and demultiplexing index information. Hereinafter, the outputs that are regarded as the first reflected wave signals will be also referred to as the “first-demultiplexer mono-reception signal outputs.”

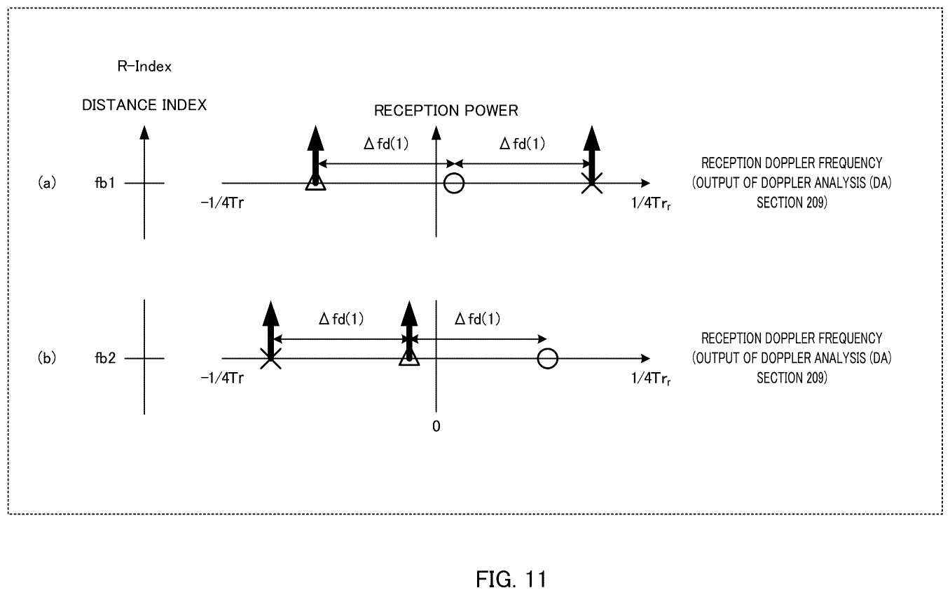

FIG. 11 illustrates an example of an output (for example, received DFreq) of DA section 209 in a case where a reflected wave signal of TxSig from first radar section 10 is received. In FIG. 11, the vertical axis represents the distance axis, and the horizontal axis represents the DFreq axis.

For example, when a DFreq peak component (hereinafter, referred to as “DF-Peak”) corresponding to interval Δfd(1) or an integer multiple of interval Δfd(1) are observed at R-Index (fb1 or fb2) illustrated in FIG. 11, first demultiplexer 211 can distinguish (for example, detect) that these DFreq peak components are reflected wave signals of TxSig transmitted from first radar section 10.

Further, for example, in FIG. 11, δ₁ (=1) DF-Index for a lower reception level is indicated by mark “∘,” and top N_{DM} (=2) DF-Peaks of reception power are indicated by marks “x” and “Δ” For example, since the DF-Indices (mark “∘”) that do not match the interval of Δfd(1) is uniquely determined in the range of −1/(2TᵣN_{sw})≤f_{d}<1/(2TᵣN_{sw}), first demultiplexer 211 can provisionally determine unique DFreq of the target object in the above range.

Further, first demultiplexer 211 can determine the association between DFreq and transmission antennas 102, for example, based on the magnitude relationship between DF-Indices (mark “∘”) and DF-Peaks (mark “x”) that match other intervals of Δfd(1).

(2) DDM Demultiplexing Processing on BMS Configuration Reception Signals (in Case where δ_{q}>0):

First demultiplexer 211 performs the following processing using the outputs (f_{bp}^{BMS}, f_{sdcp}^{BMS}, and reception power information PowerFT_{q}^{Sep}(f_{bp}^{BMS}, f_{sdcp}^{BMS}+(ndm−1)×N_{Δfd(qe)})) of distance-demultiplexing BMS-configuration CFAR in first CFAR section 210.

In first demultiplexer 211, for example, the DFreq of the target object may be temporarily determined assuming that −1/(2TᵣN_{sw})≤f_{d}<1/(2TᵣN_{sw}). Since DFreq of the target object is finally determined by subsequent determiner 212, the determination by first demultiplexer 211 is also referred to as “provisional determination” or “provisional decision.” Further, the fact that a large difference (for example, the difference is equal to or larger than a threshold) between the reception levels of top N_{DM}(qe) DF-Indices of the reception power and the reception levels of δ_{qe} DF-Indices different from the top N_{DM}(qe) DF-Indices may be utilized. For example, first demultiplexer 211 compares the reception power information input from first CFAR section 210 and provisionally determines DFreq. Note that an exemplary operation of first demultiplexer 211 is disclosed in, for example, PTL 3. Therefore, the description of the exemplary operation is omitted here.

For example, first demultiplexer 211 associates the DS amounts of the DDM signal to be transmitted with f_{sdcp}^{BMS}+(ndm−1)×N_{Δfd(qe)}, based on the relationship between δ_{qe} DF-Indices with small reception levels and top N_{DM} (qe) DF-Indices with high reception power, and outputs the DS amount and f_{sdcp}^{BMS}+(ndm−1)×N_{Δfd(qe)} to second demultiplexer 211 and determiner 212 as demultiplexing index information f_{Tx}(qe)=(f_{dmlTx #1}(qe), . . . , f_{dmlTx #NDM}(qe)) on the DDM signal.

Here, f_{dmlTx #n}(qe) indicates the DF-Index of a reflected wave signal of TxSig from nth transmission antenna 102 (Tx #n) of qeth radar section 10. As described above, first demultiplexer 211 regards the output of first DA section 209 corresponding to demultiplexing index information f_{Tx}(qe) on the DDM signal, as the second reflected wave signal, and outputs information related to the demultiplexed first demultiplexer multi-reception signal to second demultiplexer 211. The information related to the demultiplexed signal may include, for example, an R-Index (hereinafter, referred to as f_{bp}^{BMS}) corresponding to the demultiplexed second demultiplexer multi-reception signal and a demultiplexing index information f_{Tx}(qe) (hereinafter, referred to as f_{Tx}(qe, f_{bp}^{BMS})) of the DDM signal in f_{bp}^{BMS}. Further, the output of first demultiplexer 211 may include the output from first DA section 209. Hereinafter, the output regarded as the second reflected wave signal will be also referred to as the “first demultiplexer multi-reception signal output.” Note that, the R-Index information (f_{bp}^{BMS}) outputs the R-Index information as corrected obtained by adding an R-Index (for example, Bw×Td) corresponding to the propagation distance (Td×Co) for transmission delay Td.

(3) DDM Demultiplexing Processing on MNS Configuration Reception Signals (in Case where δ_{q}=0):

First demultiplexer 211 performs the following processing using the outputs (f_{bp}^{Mono}, f_{sdcp}^{Mono}, and reception power information PowerFT_{q}^{Mono}(f_{bp}^{Mono}, f_{sdcp}^{Mono}+(ndm−1)×N_{Δfd(q)})) of distance-demultiplexing MNS-configuration CFAR of first CFAR section 210. In first demultiplexer 211, for example, DFreq of the target object may be temporarily determined by assuming that −1/(2TᵣN_{sw}N_{dm(q)})<f_{d}<1/(2TᵣN_{sw}N_{dm(q)}). Hereinafter, first demultiplexer 211 performs the same output as that in a case of δ_{q}>0.

### [Exemplary Operation of Second CFAR Section 210]

For example, second CFAR section 210 of qth radar section 10 may perform the following operations in order to receive a reflected wave signal of TxSig from qeth radar section 10 that are transmitted in the same-frequency transmission in the BMS configuration.

Here, “qe” represents a radar number of radar section 10 that differs from qth radar section 10. For example, “qe” may be 2 in the case of first radar section 10 (q=1), or “qe” may be 1 in the case of second radar section 10 (q=2).

< (i) Case where DS Section 101 Sets DDM Intervals in the MNS Configuration and BMS Configuration to the Same Value>

Second CFAR section 210 may perform peak detection by, for example, searching, in the power addition values of outputs from second DA sections 209 of first to Na(q)th analyzers 206, for a power peak that matches the DDM interval (Δfd(q)=Δfd(qe)) set for TxSig of transmitter 100 of each of qth radar section 10 and qeth radar section 10 for each R-Index, and performing adaptive threshold processing.

Here, for example, when δ_{q} is set to a positive integer in DS sections 101, an interval of Δfd(q) or an interval of an integer multiple of Δfd(q) is used as an interval of the DS amounts (where q may be 1 or 2 and Δfd(1) may be equal to Δfd(2)). Therefore, signals on which DDM is performed can be detected as aliasing at an interval of Δfd(q) in the DFreq domain of the outputs of second DA sections 209. By using such characteristics, for example, the DC-CFAR processing described for the operation of first CFAR section 210 can be applied. For example, second CFAR section 210 performs the DC-CFAR processing by calculating a power addition value using outputs “VFT_{z,q}^{Mix}(f_{b}, fₛ)” from second DA sections 209 of first to Na(q)th analyzers 206 as given by Expressions 17 and 18 instead of “VFT_{z,q}^{Sep}(f_{b}, fₛ)” in Expressions 14 and 15.

Subsequent operations in the case where the DC-CFAR processing is used in CFAR section 210 will be described below. In this case, second CFAR section 210, for example, adaptively sets a threshold and outputs R-Index f_{bp}^{Mix} and DFreq index f_{sdcp}^{Mix} at which the reception power is larger than the threshold, and reception power information (PowerFT_{q}^{Mix} (f_{bp}^{Mix},f_{sdcp}^{Mix}+(ndm−1)×N_{Δfd(q)})) to second demultiplexer 211. Here, ndm is an integer of 1 to N_{DM}(q)+δ_{q}. As described above, in a case where the DDM intervals configured for the TxSig from qeth radar section 10 and the DDM intervals configured for the TxSig from qth radar section 10 match each other, a reflected wave signal in the MNS configuration may also be detected, and hereinafter, the CFAR processing in such second CFAR section 210 will be also referred to as “mono-& multi-reception CFAR.”

$$\begin{matrix}( Expression 17 ) & \\ {PowerDDM}_{q} ( {f}_{b} , {f}_{sdc} ) = {\sum }_{ndm = 1}^{{N}_{DM} ( q ) + {δ}_{q}} {PowerFT}_{q}^{Mix} ( {f}_{b} , {f}_{sdc} + ( ndm - 1 ) \times {N}_{Δ {f}_{d} ( q )} ) & [ 17 ]\end{matrix}$$

$$\begin{matrix}( Expression 18 ) & \\ {PowerFT}_{q}^{Mix} ( {f}_{b} , {f}_{s} ) = {\sum }_{z = 1}^{{N}_{a} ( q )} {\vert {VFT}_{z , q}^{Mix} ( {f}_{b} , {f}_{s} ) \vert}^{2} & [ 18 ]\end{matrix}$$

< (ii) Case where DS Section 101 Sets DDM Intervals in the MNS Configuration and BMS Configuration to Different Values>

In order to receive the fourth reflected wave signal of TxSig from qeth radar section 10, second CFAR section 210 may perform peak detection by, for example, searching, in the power addition values of outputs from second DA sections 209 of first to Na(q)th analyzers 206, for a power peak that matches the DDM interval (Δfd(qe)) set for TxSig of transmitter 100 of each of qth radar section 10 and qeth radar section 10 for each R-Index, and performing adaptive threshold processing. Hereinafter, a similar CFAR processing in second CFAR section 210 described above will be performed. With such processing, even when a reflected wave signal in the MNS configuration is mixed, it is possible to not extract the reflection signal in the MNS configuration in second CFAR section 210 by using the inconsistency in the DDM intervals. Further, also in a case where the number of DDM multiplexing is different, it is possible to prevent the reflection signal in the MNS configuration from being extracted. Further, the CFAR processing in second CFAR section 210 described above will be also referred to as “multi-reception CFAR” hereinafter.

### [Exemplary Operation of Second Demultiplexer 211]

Second demultiplexer 211 of qth radar section 10 performs DDM demultiplexing on the third reflected wave signals in the MNS configuration and the fourth reflected wave signals in the BMS configuration, for example, using the outputs (for example, the Doppler frequency components of the reception signals) of first demultiplexer 211, second CFAR section 210, and second DA section 209.

Here, the first reflected wave signals in the MNS configuration are demultiplexed by first demultiplexer 211. Therefore, second demultiplexer 211 regards the outputs of second DA section 209 corresponding to DDM-signal demultiplexing index information f_{Tx}(q) as the third reflected wave signals, and outputs it to determiner 212. Hereinafter, the outputs regarded as the third reflected wave signals are also referred to as “second-demultiplexer mono-reception signal outputs.”

Further, at the time of outputting the second-demultiplexer mono-reception signal output, in a case where the Doppler shift configuration in DS section 101 in each of the plurality of radar sections 10 includes patterns of DS amounts which do not match each other even with cyclic shifting (for example, configuration example 1-a-), in a case where the numbers of DDM are different (for example, configuration example 1-b), or in a case where the intervals of Δfd(q) are set to different values in the BMS configuration (for example, configuration example 2-a), second demultiplexer 211 may determine whether or not the pattern of DS amounts matches the pattern of DS amounts of the Doppler shift configuration in the above MNS configuration, whether or not the numbers of DDM match each other, or whether or not the interval matches the interval of Δfd(q). By such determination, second demultiplexer 211 can suppress the fourth reflected wave signal from being regarded erroneously as the third reflected wave signal.

Meanwhile, second demultiplexer 211 treats, as the fourth reflected wave signal, an output from second CFAR section 210 that does not match (or does not correspond to) DDM-signal demultiplexing index information f_{Tx}(q), and outputs the signal subjected to the DDM demultiplexing to second angle measurer 213. Hereinafter, the output subjected to the DDM multiplexing in second demultiplexer 211 as described above is also referred to as “second-demultiplexer multi-reception-signal output.”

The latter DDM demultiplexing operation is, for example, a DDM demultiplexing operation based on information inputted from second CFAR section 210 that does not match DDM-signal demultiplexing index information f_{Tx}(q) (for example, that allows consideration as multi-reception). Accordingly, the operations of second demultiplexer 211 are the same as the operations in which each of the information input from second DA section 209 and the information input from second CFAR section 210 is used instead of the information input from first DA section 209 and first CFAR section 210 in first demultiplexer 211. Therefore, a description of such operations of second demultiplexer 211 will be omitted.

For example, second demultiplexer 211 outputs, to second angle measurer 213, demultiplexing index information f_{Tx}(qe) on the DDM signal obtained by associating the DS amount of a DDM signal to be transmitted and f_{sdcp}^{Mix}+(ndm−1)×N_{Δfd(qe)} with reception power information (PowerFT_{q}^{Mix}(f_{bp}^{Mix}, f_{sdcp}^{Mix}+(ndm−1)×N_{Δfd(qe)})) for R-Index f_{bp}^{Mix} and DF-Index f_{sdcp}^{Mix} at which peak detection is performed by multi-reception CFAR and which do not match demultiplexing index information f_{Tx}(q) on the DDM signal, based on the relationship between δ_{qe} DF-Indices with small reception levels and top N_{DM}(qe) DF-Indices with high reception powers. Here, f_{Tx}(qe) indicates DF-Index of the reflected wave signal of TxSig transmitted from each transmission antenna 102 of qeth radar section 10.

Further, second demultiplexer 211 outputs, for example, information on the demultiplexed second-demultiplexer multi-reception signal to second angle measurer 213. The information related to the demultiplexed signal may include, for example, an R-Index (hereinafter, referred to as f_{bp}^{BMS}) corresponding to the demultiplexed second demultiplexer multi-reception signal and demultiplexing index information f_{Tx}(qe) (hereinafter, referred to as f_{Tx}(qe, f_{bp}^{BMS})) on the DDM signal in f_{bp}^{BMS} The outputs of second demultiplexer 211 may include an output from second DA section 209. Note that, the detectable DFreq range ±1/(2TrN_{sw}) is achieved. Note that, R-Index information (f_{bp}^{BMS}) outputs R-Index information as corrected by subtracting an R-Index (for example, Bw×Td) corresponding to propagation distance (Td×Co) for transmission delay Td.

### [Exemplary Operation of Determiner 212]

For example, determiner 212 performs DFreq determination (for example, DFreq aliasing determination) based on the first reflected wave signals and the third reflected wave signals.

For example, determiner 212 determines DFreq based on the phase difference between reception signals of the reflected wave signal in the MNS configuration demultiplexed in first demultiplexer 211 and second demultiplexer 211. As a result, the observable DFreq range in radar apparatus 1 can be enlarged (for example, the DFreq range can be enlarged to ±1/(2Tr)), and the detectable maximum DFreq can be increased. Note that the Doppler determination result obtained by enlarging the DFreq range observable by determiner 212 together with the outputs from first demultiplexer 211 and second demultiplexer 211 may be output, for example, to first angle measurer 213.

For example, when DA section 209 assumes relative velocity Vₜ of a target object for which the DFreq range is ±1/(2Tr) with respect to unambiguously observable DFreq (for example, a frequency range ±1/(2TᵣN_{sw})), determiner 212 determines DFreq of the target object (for example, an aliasing of DFreq) based on the phase difference between the output of second DA section 209 and the output of first DA section 209 in DDM-signal demultiplexing index information f_{Tx}(q). As a result, the DFreq range detectable by radar apparatus 1 can be expanded (for example, the frequency range can be expanded to ±1/(2Tr)).

For example, when N_{sw}=2 and when DFreq in the frequency range ±1/(2TᵣN_{sw}) corresponding to the DDM-signal demultiplexing index that is the output of first demultiplexer 211 is fd1, DFreq of the target object may be fd1 or fd1±1/(N_{sw}Tᵣ) considering DFreq aliasing in the frequency range ±1/(2Tr).

For example, the phases of reception signals for DF-Indices corresponding to DFreq fd1 in first DA section 209 and second DA section 209 are denoted as ϕ₁(fd1) and ϕ₂ (fd1), respectively. In first radar section 10, for example, each of first DA section 209 and second DA section 209 performs Doppler analysis at a cycle of N_{sw}Tr, as shown in FIG. 4. Considering that the time difference of Tr+Td is included in the observation times of first DA section 209 and second DA section 209, the DFreq aliasing occurs and the DFreq is determined to be fd1±1/(N_{sw}Tr) in a case where the phase difference ΔΦ(fd1)=ϕ₂ (fd1)−ϕ₁(fd1)−2πfd1×(Tr+Td) of ϕ₁ (fd1) and ϕ₂ (fd1) is ΔΦ(fd1)=±1/(N_{sw}Tr)×2π(Tr+Td)=±(2π/N_{sw})×(1+Td/Tr). On the other hand, in a case where ΔΦ(fd1)=0, it is determined that DFreq aliasing does not occur and the DFreq is fd1.

Similarly, in second radar section 10, for example, as shown in FIG. 4, each of first DA section 209 and second DA section 209 performs the Doppler analysis in a cycle of N_{sw}Tr. Considering that the time difference of Tr−Td is included in the observation times of first DA section 209 and second DA section 209, the DFreq aliasing occurs and the DFreq is determined to be fd1±1/(N_{sw}Tr) in a case where the phase difference ΔΦ(fd1)=ϕ₂ (fd1)−ϕ₁(fd1)−2πfd1×(Tr−Td) of ϕ₁(fd1) and ϕ₂ (fd1) is ΔΦ(fd1)=±1/(N_{sw}Tr)×2π(Tr−Td)=±(2π/N_{sw})×(1−Td/Tr). On the other hand, in a case where ΔΦ(fd1)=0, it is determined that DFreq aliasing does not occur and the DFreq is fd1.

### [Exemplary Operation of First Angle Measurer 213]

For example, first angle measurer 213 of qth radar section 10 performs angle measurement of the target object using the first and the third reflected wave signals based on information inputted from first demultiplexer 211 and second demultiplexer 211 via determiner 212 (for example, R-Index f_{bp}(q) and DDM-signal demultiplexing index information f_{Tx}(q)). For example, first angle measurer 213 may perform angle measurement based on DFreq aliasing determination by determiner 212.

For example, first angle measurer 213 performs angle measurement by extracting the outputs of DA sections 209 based on f_{bp}(q) and DDM-signal demultiplexing index information f_{Tx}(q), and generating qth virtual reception array correlation vector h_{q}(f_{bp}(q), f_{Tx}(q)) of first angle measurer 213 including Nt(q)× Na(q) elements that are the product of number Nt(q) of transmission antennas and number Na(q) of reception antennas. Here, for example, q=1, 2.

Note that first angle measurer 213 may perform angle measurement for each of the outputs of first and second DA sections 209, or may perform angle measurement using a combined result using in-phase addition or power addition.

Note that there are various methods for angle measurement algorithms. For example, the estimation method disclosed in NPL 4 may be used (the same applies to the angle measurer below).

Through the above-described operations, first angle measurer 213 of qth radar section 10 may output, for example, an angle measurement value for f_{bp}(q) and DDM demultiplexing index information f_{Tx}(q) as a positioning output.

Further, f_{bp}(q) may be converted as distance information by using Expression 3 to be output.

Further, DFreq of the target object for f_{bp}(q) determined by determiner 212 may be outputted. Since the DS amounts applied by DS sections 101 at the time of transmission are known to each of transmission antennas 102, first angle measurer 213 may output DFreq of the target object based on the DDM-signal demultiplexing index information and the output of determiner 212.

### [Exemplary Operation of Second Angle Measurer 213]

Second angle measurer 213 of qth radar section 10 performs angle measurement of the target object based on, for example, the first- and the second-demultiplexer multi-reception signal outputs that are information (for example, R-Index f_{bp}(qe)) inputted from second demultiplexer 211 and DDM-signal demultiplexing index information f_{Tx}(qe). For example, second angle measurer 213 may perform angle measurement based on the second and the fourth reflected wave signals of TxSig from qeth radar section 10, which are demultiplexed in second demultiplexer 211.

For example, second angle measurer 213 performs angle measurement by extracting the outputs of DA sections 209 based on f_{bp}(qe) and DDM-signal demultiplexing index information f_{Tx}(qe), and generating qeth virtual reception array correlation matrix H_{qe}(f_{bp}(qe), f_{Tx}(qe)) of second angle measurer 213 that is composed of a Nt(qe)×Na(q)-order matrix. Here, for example, qe=1, 2.

Second angle measurer 213 of qth radar section 10 may output, for example, the direction of departure as an angle measurement value (for example, a positioning output) to integrator 30.

Further, second angle measurer 213 of qth radar section 10 may output, for example, the angle measurement to integrator 30 as a measurement angle value (for example, a positioning output) in the direction of arrival. As the angle measurement, for example, the angle measurement in the BMS configuration described in NPL 5 or 6 may be used.

Through the above operations, second angle measurer 213 of qth radar section 10 may output, for example, the direction-of-departure angle measurement value and the direction-of-arrival angle measurement value for f_{bp}(qe) and DDM-signal demultiplexing index information f_{Tx}(qe) as the positioning output.

Further, f_{bp}(qe) may be converted as distance information by using Expression 4 to be output.

Since the DS amounts applied by DS sections 101 at the time of transmission are known to each of transmission antennas 102, second angle measurer 213 may output DFreq of the target object based on the DDM-signal demultiplexing index information.

A method for estimating a target-object position in a radar having a BMS configuration is described in, for example, NPL 5 or 6. Thus, a detailed description of the estimation method will be omitted. Note that, in the above-described example, an example in which angle measurer 213 measures the direction of departure or arrival has been described, but the present disclosure is not limited thereto, and it is also possible to measure the angle in the elevation angle direction or the angle in the direction of departure or arrival and the elevation angle direction by the antenna arrangement of each radar. For example, angle measurer 213 may calculate the direction of departure or arrival and the elevation angle direction as the angle measurement values, and may use them as the positioning output.

The exemplary operation of second angle measurer 213 has been described above.

### [Exemplary Operation of Integrator 30]

In FIG. 3, integrator 30 performs positioning of a target object by integrating the positioning outputs of first angle measurer 213 and second angle measurer 213 from first radar section 10 and the positioning outputs of first angle measurer 213 and second angle measurer 213 from second radar section 10.

Note that, in a case where integrator 30 assumes that a transmission timing error or a frequency error is included in transmission signals between first radar section 10 and second radar section 10, distance corrector 301 in integrator 30 corrects the detected distance. Hereinafter, an exemplary operation of distance corrector 301 will be described.

Distance corrector 301 in integrator 30 receives inputs of f_{bp}^{BMS} (hereinafter, represented as f_{bp}^{BMS}(1)), which is an R-Index output in a BMS configuration, from among positioning outputs from second angle measurer 213 of first radar section 10 and f_{bp}^{BMS} (hereinafter, represented as f_{bp}^{BMS}(2)), which is an R-Index output in a BMS configuration, from among positioning outputs from second angle measurer 213 of second radar section 10 as inputs.

In a case where the transmission timing error (or including a frequency error) between first radar section 10 and second radar section 10 is already known and variation is small to the ignorable extent (for example, in a case of a fixed error), it is possible for distance corrector 301 to perform distance correction based on the distance error due to the transmission timing error.

For example, when transmission time (t1) of first radar section 10 is set as a reference, transmission timing error ΔTx of the transmission signal at transmission time (t2) in second radar section 10 is ΔTx=t2−t1, and the distance response obtained in the BMS configuration in which transmission from first radar section 10 and reception in second radar section 10 are performed includes a distance error of −C_{0Δ}Tx. Further, the distance response obtained with the BMS configuration in which transmission is performed from second radar section 10 and reception is performed by first radar section 10 includes a distance error of C₀ΔTx. Distance corrector 301 converts f_{bp}^{BMS}(1), which is an R-Index output in the BMS configuration into distance information by using Expression 4 and sets the converted information as output R(f_{bp}^{BMS}(1)), and outputs distance information R(f_{bp}^{BMS}(1))−C₀ΔTx in which a distance error has been corrected. Similarly, distance corrector 301 converts f_{bp}^{BMS}(2), which is an R-Index output in the BMS configuration into distance information by using Expression 4 and sets the converted information as output R(f_{bp}^{BMS}(2)), and outputs distance information R(f_{bp}^{BMS}(2))+C₀ΔTx in which a distance error has been corrected.

Note that, in a case where such a fixed transmission timing error exists, the operation of correcting the distance error in angle measurer 213 in each radar section 10 may be used. Thus, each radar section 10 is capable of performing positioning output using information in which the distance error is corrected.

Further, in a case where the transmission timing error (or including a frequency error) between first radar section 10 and second radar section 10 varies gradually (for example, a case where a substantially constant transmission timing error is obtained within Nc times of transmission periods Tr), distance corrector 301 corrects the distance error due to the transmission timing error as follows. Note that, here, the directivities of transmission antenna 102 and reception antenna 202 of each radar section 10 are the same.

In this case, since transmission from first radar section 10 and transmission from second radar section 10 are performed simultaneously, the distance response obtained with the BMS configuration in which first radar section 10 performs transmission and second radar section 10 performs reception and the distance response obtained with the BMS configuration in which second radar section 10 performs transmission and first radar section 10 performs reception are obtained as substantially the same distance response. For this reason, for example, even when transmission timing error ΔTx is unknown, as described above, the distance response obtained with the BMS configuration in which transmission is performed from first radar section 10 and reception is performed by second radar section 10 includes a distance error of −C₀ΔTx, and the distance response obtained with the BMS configuration in which transmission is performed from second radar section 10 and reception is performed by first radar section 10 includes a distance error of C₀ΔTx, and it is thus possible by averaging these distance responses to calculate the distance in which transmission timing error ΔTx is canceled out. Distance corrector 301 may correct the error in distances to the target object based on the average value between the distance calculated based on f_{bp}^{BMS}(1), which is an R-Index output (range component of the reflected wave signal) in the BMS configuration and the distance calculated based on f_{bp}^{BMS}(2). Distance corrector 301 outputs distance information in which a distance error has been corrected. For example, distance corrector 301 may output (R(f_{bp}^{BMS}(1))+R(f_{bp}^{BMS}(2)))/2 or a distance error estimation value corresponding to C₀ΔTx (for example, (R((f_{bp}^{BMS}(1))−R(f_{bp}^{BMS}(2)))/2 or (R(f_{bp}^{BMS}(2)−R(f_{bp}^{BMS}(1)))/2).

Note that, in a case where each of R-Index, which a distance response obtained in the BMS configuration in which transmission is performed from first radar section 10 and reception is performed by second radar section 10 and R-Index, which a distance response obtained in the BMS configuration in which transmission is performed from second radar section 10 and reception is performed by first radar section 10 is output multiple times, relative distance relationships between this plurality of reception signals are the same relationships (since a constant distance error is included in the plurality of reception signals, the relationship is a relationship in which the R-Indices match when shifted (caused to be offset) by a specific number of Indices (ΔN_{index}) in the R-Index direction). For this reason, a pair of R-Indices for distance correction between BMSs can be extracted, and distance corrector 301 can perform the distance correction even in a case where a plurality of R-Index outputs are included. Further, the above-described ΔN_{index} represents a distance error estimation value corresponding to C₀ΔTx, and distance corrector 301 may output, for example, the distance error estimation value as R(ΔN_{index}/2). Further, distance corrector 301 may output distance information in which a distance error is corrected using the distance error estimation value.

The distance correction in distance corrector 301 as described above makes it possible to reduce an error in the detected distance in a BMS configuration. Further, in integrator 30, the positioning processing in the BMS configuration may be performed by using the output in which distance correction is performed in the BMS configuration by distance corrector 301 and the outputs from second angle measurer 213 of each radar section 10, and thus, it is possible to prevent the radar positioning performance from deteriorating.

For example, integrator 30 may determine the type of the target object based on a consistency between a positioning result of second angle measurer 213 of first radar section 10 and a positioning result of second angle measurer 213 of second radar section 10, which are the positioning results in the BMS configuration. For example, integrator 30 may utilize the tendency of a high consistency in the case of poles (metal poles) and a low consistency at a reflection point in the case of a target object having a large horizontal dimension, such as a wall.

Further, for example, when a detected area overlap between the positioning output of first angle measurer 213 of first radar section 10 and the positioning output of first angle measurer 213 of second radar section 10, which are the positioning results in the MNS configuration, integrator 30 may output highly consistent components in both of estimation results. For example, integrator 30 may not output less consistent components between both of the estimation results. In this case, integrator 30 can remove multipath reflection or the like that becomes a virtual image.

Note that integrator 30 may output the positioning output (or the positioning result) to, for example, a control apparatus (ECU or the like) of a vehicle in the case of an in-vehicle radar, or to an infrastructure control apparatus in the case of an infrastructure radar, which are not illustrated.

As described above, in the present embodiment, radar apparatus 1 includes first radar section 10 that transmits the first radar transmission signal and second radar section 10 that transmits the second radar transmission signal. Here, in the plurality of transmission periods in which the first radar transmission signal and the second radar transmission signal are transmitted, there are a transmission period including predetermined transmission delay Td and a transmission period not including transmission delay Td, and for example, these transmission periods are configured alternately and such that the transmission periods including transmission delay Td are not matched between first radar section 10 and second radar section 10.

Thus, radar apparatus 1 can receive a reception signal of a reflection wave in the MNS configuration and a reception signal of a reflection wave in the BMS configuration by demultiplexing the reception signals, thus maintaining the radar detection performance (for example, the detectable Doppler detection range) in the MNS configuration, enabling inter-BMS simultaneous multiplexing transmission in addition to the simultaneous multiplexing transmission in the MNS configuration, and achieving a time-saving effect required for radar distance measurement. Therefore, according to the present embodiment, the target object can be efficiently detected in radar apparatus 1.

Further, in addition to the above, in a plurality of transmission periods in which the first radar transmission signal and the second radar transmission signal are transmitted, a transmission period including predetermined transmission delay Td and a transmission period not including transmission delay Td are alternately configured. As a result, radar apparatus 1 can detect a reception signal of a reflection wave obtained in a BMS configuration in which transmission is performed from first radar section 10 and reception is performed by second radar section 10 and can detect a reception signal of a reflection wave obtained in a BMS configuration in which transmission is performed from second radar section 10 and reception is performed by first radar section 10. Further, distance corrector 301 can correct a distance error due to a transmission timing error (including a frequency error) between first radar section 10 and second radar section 10 using these detection results, and thus, it is possible to prevent the degradation in the radar positioning performance in a BMS configuration.

Note that while the Doppler detection range based on the output of second demultiplexer 211 is ±1/(2TᵣN_{sw}) for detection of DFreq in the BMS configuration in the present embodiment, the Doppler detection result in the MNS configuration may be used when the target object can be regarded as the same target between the BMS configuration and the MNS configuration. Thus, it is possible to expand the Doppler detection range to ±1/(2Tr) in the BMS configuration for performing Doppler detection based on the output of determiner 212.

Further, in the present embodiment, operations of first radar section 10 and second radar section 10 are described as an example of a case where, as shown in FIG. 4, there are transmission periods including predetermined transmission delay Td and transmission periods not including transmission delay Td in the plurality of transmission periods in which the first radar transmission signal and the second radar transmission signal are transmitted, these transmission periods are alternately configured, and controller 104 performs configuration such that the transmission periods including transmission delay Td do not match between first radar section 10 and second radar section 10 in the BMS configuration, but the present disclosure is not limited thereto.

Note that, in the present embodiment, as shown in FIG. 4, controller 104 has a transmission period including predetermined transmission delay Td and a transmission period not including transmission delay Td in a plurality of transmission periods in which a first radar transmission signal and a second radar transmission signal are transmitted, and receiver 200 of radar apparatus 1 performs Doppler analysis by using Doppler analysis sections 209 different between the transmission period including predetermined transmission delay Td and the transmission period not including transmission delay Td. Here, an operation in a case where DS amounts DOPₙ(q) and the number of Doppler multiplexing DDM numbers N_{DM}(q) applied by DS sections 101 in a transmission period including transmission delay Td and DS amounts DOPₙ(q) and the number of Doppler multiplexing DDM numbers N_{DM}(q) applied by DS sections 101 in a transmission period not including transmission delay Td are set to be the same has been described, but the present disclosure is not limited thereto.

For example, DS amount DOPₙ(q) and the number of Doppler multiplexing DDM numbers N_{DM}(q) applied by DS sections 101 in the transmission period including transmission delay Td may be made different from DS amount DOPₙ(q) and the number of Doppler multiplexing DDM numbers N_{DM}(q) applied by DS sections 101 in the transmission period not including transmission delay Td.

For example, qth radar section 10 may configure DS amount DOPₙ(q) applied by DS sections 101 in a transmission period including transmission delay Td by setting δ_{q}=0 and N_{DM}(q)=2 in Expression 7, and may configure DS amount DOPₙ(q) applied by DS sections 101 in a transmission period not including transmission delay Td by setting δ_{q}=0 and N_{DM}(q)=1 in Expression 7.

For example, qth radar section 10 may also configure DS amount DOPₙ(q) applied by DS sections 101 in a transmission period including transmission delay Td by setting δ_{q}>0 and N_{DM}(q)=2 in Expression 7, and may configure DS amount DOPₙ(q) applied by DS sections in a transmission period not including transmission delay Td by setting δ_{q}>0 and N_{DM}(q)=1 in Expression 7.

With such a configuration, in a transmission period including transmission delay Td, qth radar section 10 transmits transmission signals to which different DS amounts are applied, from each of the plurality of transmission antennas, and in a transmission period not including transmission delay Td, qth radar section 10 transmits a transmission signal from one transmission antenna. Thus, in a transmission period that allows distance demultiplexing, the reception signal of the reflection wave transmitted from one transmission antenna becomes distance demultiplexable in a BMS configuration. Since DDM multiplexing transmission is not used, fluctuation in the reception powers in beat analyzer 208 at respective transmission periods is suppressed, and it is not necessary to smooth the reception powers. In addition, an effect is obtained, which allows distance corrector 301 to perform the distance error correction in the BMS configuration at a DDM basic cycle.

In addition, an example in which DS amount DOPₙ(q) and the number of Doppler multiplexing DDM numbers N_{DM}(q) applied by DS sections 101 in a transmission period including transmission delay Td is made different from DS amount DOPₙ(q) and the number of Doppler multiplexing DDM numbers N_{DM}(q) applied by DS section 101 in a transmission period not including transmission delay Td is not limited to the above-described example. For example, in the transmission period including transmission delay Td, qth radar section 10 may transmit a transmission signal from one transmission antenna, and in the transmission period not including transmission delay Td, qth radar section 10 may transmit transmission signals to which different DS amounts are applied respectively from a plurality of transmission antennas.

Further, in the present embodiment, the exemplary operation is described by using an example (for example, the example shown in FIG. 4) in which controller 104 configures the transmission period including predetermined transmission delay Td and the transmission period not including transmission delay Td alternately and such that the transmission periods including predetermined transmission delay Td do not match between first radar section 10 and second radar section 10, and these transmission periods are repeated in the transmission period of 2Tr, but the present disclosure is not limited to such a configuration. For example, controller 104 may perform a configuration such that in a certain transmission period among transmission periods N_{sw}×Tr in which the transmission timing is repeated in a predetermined pattern, transmission delay Td is included for first radar section 10, but transmission delay Td is not included for second radar section 10, and in another transmission period, transmission delay Td is not included for first radar section 10, and transmission delay Td is included for second radar section 10. Thus, the effect in the present embodiment is obtained. For example, radar apparatus 1 is capable of receiving a reception signal of a reflection wave in an MNS configuration and a reception signal of a reflection wave in a BMS configuration in a demultiplexed manner, and the error of the detected distance in a BMS configuration can be reduced even in a case where the transmission timing error (including a frequency error) between first radar section 10 and second radar section 10 varies within Nc times of transmission periods Tr due to the distance correction in distance corrector 301.

Hereinafter, another example (variation) of the operation of first radar section 10 and second radar section 10 will be described. In the following, operations different from the operation of the above-described embodiment will be mainly described.

### (Variation 1)

In Embodiment 1, an exemplary configuration and an exemplary operation in a case where the variation in the transmission timing error (including a frequency error) between first radar section 10 and second radar section 10 is small (for example, a case where the variation in the transmission timing error within Nc times of transmission periods Tr is ignorable) have been described. With the above-described configuration, radar apparatus 1 detects a reception signal in the MNS configuration at a cycle of N_{C}Tr, detects a reception signal in the BMS configuration, and makes it possible to perform distance correction due to a transmission timing error (including a frequency error).

On the other hand, in a case where the variation in the transmission timing error (including a frequency error) between first radar section 10 and second radar section 10 is large (for example, in a case where the variation in the transmission timing error within Nc times of transmission periods Tr is not ignorable), the outputs of DA sections 209 are not detected as the sharp peak since the Doppler frequency in the reception signal with the BMS configuration is not constant, and thus, the detection accuracy of the transmission timing error (including the frequency error) may deteriorate.

Accordingly, in Variation 1, an exemplary configuration will be described, in which the reception signal with the BMS configuration is detected while improving the detection accuracy of a transmission timing error (including a frequency error) by performing the detection of the transmission timing error (including the frequency error) with a shorter cycle (for example, a cycle of N_{sw}Tr or a cycle of an integer multiple thereof) using the output of beat analyzer 208.

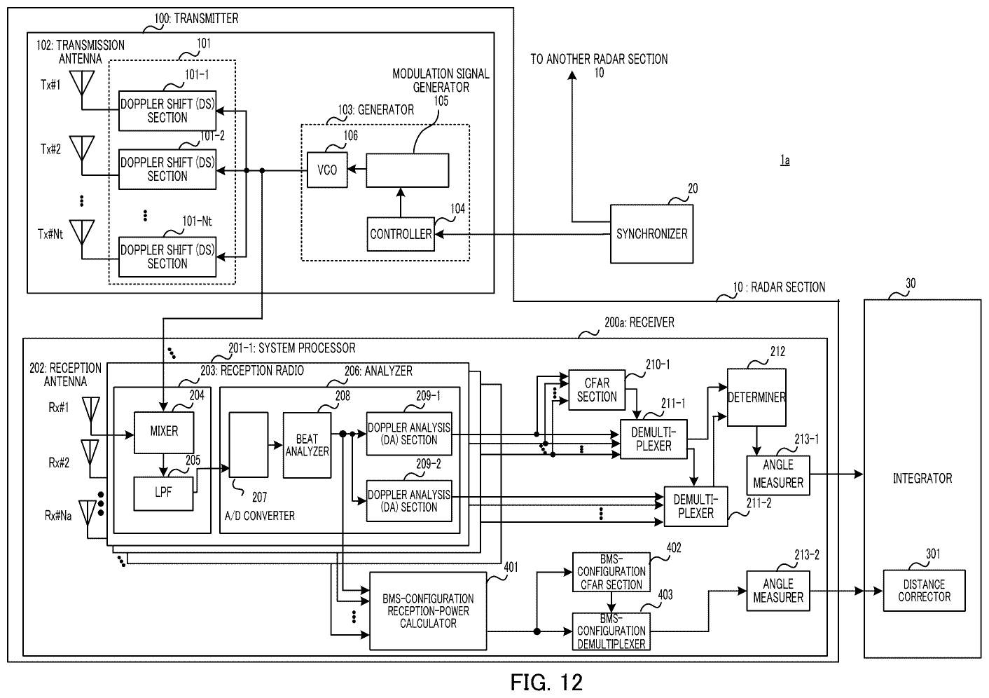

Hereinafter, a configuration diagram of a radar apparatus in Variation 1 is shown and the operation thereof will be described. FIG. 12 is a block diagram showing an exemplary configuration of radar apparatus 1a according to Variation 1. Note that, in FIG. 12, the description of operations same as those of configuration in FIG. 3 will not be shown, and operations different from those in FIG. 3 will be described.

Such a radar apparatus 1a shown in FIG. 12, by using a configuration different from the configuration in the embodiment described above, it is possible to detect a reception signal in the BMS configuration in a cycle of N_{sw}Tr or a cycle of an integer multiple thereof and at the same time, it is possible to perform distance correction due to a transmission timing error (including a frequency error). Even in a case where a fluctuation in the transmission timing error (including a frequency error) is large, it is possible to prevent the distance detection accuracy of a BMS configuration from deteriorating and to prevent the radar positioning performance from deteriorating.

Note that, since BMS-configuration reception-power calculator 401, BMS-configuration CFAR section 402, and BMS-configuration demultiplexer 403 shown in FIG. 12 are used in the demultiplexing of the reception signal with the BMS configuration, the operations of first DA section 209, first CFAR section 210, and first demultiplexer 211 are different from those in the above-described embodiment.

First DA section 209 in zth analyzer 206 of qth radar section 10 outputs the Doppler analysis result of the reflected wave signal with the MNS configuration in output VFT_{z,q}^{Sep} (f_{b}, fₛ) of the mono-& multi-demultiplexing reception DA section. As the operation of first DA section 209, the Doppler analysis operation on the reflected wave signal in accordance with the BMS configuration may not be included. For example, first DA section 209 outputs the Doppler analysis result of the reflected wave signal with the MNS configuration using f_{b}=0, . . . , N_{Data}/2−1 in Expression 5.

Further, first CFAR section 210 may perform the operation of the distance-demultiplexing MNS-configuration CFAR processing and may not perform the operation of the distance-demultiplexing BMS-configuration CFAR processing.

First demultiplexer 211 may perform an operation related to the first-demultiplexer mono-reception signal output and may not perform an operation related to the first demultiplexer multi-reception signal output. Similarly, second demultiplexer 211 may perform an operation related to the second demultiplexer mono-reception signal output and may not perform an operation related to the second demultiplexer multi-reception signal output.

Next, an exemplary operation of BMS-configuration reception-power calculator 401, BMS-configuration CFAR section 402, BMS-configuration demultiplexer 403, second angle measurer 213 (or angle measurer 213-2), and distance corrector 301 shown in FIG. 12 will be described.

BMS-configuration reception-power calculator 401 of qth radar section 10 configures the BF response obtained from the reception signal in the transmission period that allows distance demultiplexing as an input, in the same manner as that of the BF response input from beat analyzer 208 to first DA section 209 (mono/multi-demultiplexed reception DA section), calculates the reception power calculation of the BF response at a predetermined cycle, and outputs the reception power to BMS-configuration CFAR section 402 and BMS-configuration demultiplexer 403, with the BF response.

In the case BF response RFT_{z,q}(f_{b}^{BMS}, m₁) as input for the myth transmission period, f_{b}^{BMS}=−N_{data}/2, . . . , −1 is a reflected wave signal according to the BMS configuration, and BMS-configuration reception-power calculator 401 calculates the reception power of the reflected wave signal according to the BMS configuration, for example, as shown in following Expression 19:

$$\begin{matrix}( Expression 19 ) & \\ {P}_{RFT} ( {f}_{b}^{BMS} , {m}_{1} ) = {\vert {RFT}_{z , q} ( {f}_{b}^{BMS} , {m}_{1} ) \vert}^{2} & [ 19 ]\end{matrix}$$

Note that, BMS-configuration reception-power calculator 401 may perform the output after adding the reception power of BF response RFT_{z,q}(f_{b}^{BMS}, m₁) obtained from the reception signal in the transmission period that allows distance demultiplexing from plurality of analyzers 206. Thus, it is possible to reduce noise power dispersion.

Further, BMS-configuration reception-power calculator 401 may add up the reception powers of BF responses obtained from reception signals in a plurality of transmission periods that allow distance demultiplexing, and may output the added reception power. For example, in following Expression 20, the reception power of BF response RFT_{z,q}(f_{b}^{BMS}, m₁) obtained from the reception signal in the myth transmission period that allows distance demultiplexing and the reception power of BF response RFT_{z,q}(f_{b}^{BMS}, m₂) obtained from the reception signal in the m₂th transmission period after a period of N_{sw}Tᵣ, which is distance demultiplexable after the m₁th are added. Note that, following Expression 20 is used in combination with the reception power addition of the outputs of Na analyzers 206.

$$\begin{matrix}( Expression 20 ) & \\ {P}_{RFT} ( {f}_{b}^{BMS} , {m}_{1} , {m}_{2} ) = {\sum }_{z = 1}^{{N}_{a}} {\vert {RFT}_{z , q} ( {f}_{b}^{BMS} , {m}_{1} ) \vert}^{2} + {\sum }_{z = 1}^{{N}_{a}} {\vert {RFT}_{z , q} ( {f}_{b}^{BMS} , {m}_{2} ) \vert}^{2} & [ 20 ]\end{matrix}$$

Thus, it is possible to reduce noise power dispersion. Further, in a case where DDM is used, simultaneous multiplexing transmission is performed while changing the phases of a plurality of transmission antennas, and thus, the variation in the reception power in beat analyzer 208 may increase for each transmission period, and an effect of smoothing the reception power can be obtained.

Further, for example, the DDM intervals applied by DS sections 101 of qeth radar section 10 and received by qth radar section 10 in the BMS configuration, the minimum unit of phase rotation is 2π/(N_{DM} (qe)+δ_{qe}) when Expression 7 is used. From this, the reception powers of the BF responses obtained from the reception signals in a plurality of transmission periods which allow distance demultiplexing may be smoothed at a cycle of ((N_{DM}(qe)+δ_{qe})×N_{sw}Tᵣ, which is hereinafter referred to as a DDM basic cycle) in which the phase rotation is 2π or a cycle of an integer multiple of the DDM basic cycle.

Further, in a case where the DDM intervals between qth radar section 10 and qeth radar section 10 are different from each other (Δfd(1)≠Δfd(2)), BMS-configuration reception-power calculator 401 may perform smoothing of the reception powers using the least common multiple of each of the DDM basic cycles (a cycle of (N_{DM}(q)+δq)×N_{sw}Tᵣ and (a cycle of N_{DM}(qe)+δ_{qe})×N_{sw}Tᵣ) applied by DS section 101 of qth radar section 10 and qeth radar section 10. When both qth radar section 10 and qeth radar section 10 can perform smoothing at the DDM transmission cycle (or an integer multiple of the DDM basic cycle) and DDM is used, the reception power for each transmission period in beat analyzer 208 can be prevented from being varied, and then distance correction in distance corrector 301 can be performed. It is thus possible to improve the distance correction accuracy. Here, for example, qe=1, 2.

Further, the number of times the reception powers are added in BMS-configuration reception-power calculator 401 may be configured according to the variation situation of the transmission timing error (or including a frequency error) between first radar section 10 and second radar section 10. For example, in a case where the variation in the transmission timing error is large, the addition of the reception powers of the BF responses obtained from the reception signals in a plurality of transmission periods allowing distance demultiplexing may not be performed (for example, Expression 19), or may be performed several times (for example, Expression 20). It is thus possible to perform by the distance correction in distance corrector 301, error correction depending on a variation in the transmission timing error (or including a frequency error), and to improve the distance correction accuracy.

BMS-configuration CFAR section 402 performs CFAR processing (for example, adaptive threshold determination) using the input for each predetermined period from BMS-configuration reception-power calculator 401, and extracts an R-Index that gives a local peak signal. Hereinafter, a local peak signal in a reception signal of a BMS configuration that is detected in a distance demultiplexing manner will be referred to as an R-Index f_{bp}^{BMS} The CFAR processing in BMS-configuration CFAR section 402 performs CFAR processing of one dimension in the distance direction (for example, processing disclosed in Non-Patent Literature 3 may be applied).

BMS-configuration demultiplexer 403 in qth radar section 10 performs, for example, demultiplexing of a reflected wave signal in the BMS configuration using the output of BMS-configuration CFAR section 402 and the output (for example, the range component of the reception signal) of BMS-configuration reception-power calculator 401. For example, BMS-configuration demultiplexer 403 of qth radar section 10 demultiplexes and extracts a reception signal in the BMS configuration using inputs from BMS-configuration reception-power calculator 401 and BMS-configuration CFAR section 402 at a predetermined period. For example, BMS-configuration demultiplexer 403 uses output f_{bp}^{BMS} of BMS-configuration CFAR section 402 and outputs, to second angle measurer 213, the output (for example, P_{RFT}(f_{b}^{BMS}, m₁) or P_{RFT} (f_{b}^{BMS}, m₁, m₂)) from BMS-configuration reception-power calculator 401, which gives a local peak signal, and the BF response (for example RFT_{z,q} (f_{b}^{BMS}, m₁) and the like) used for BMS-configuration reception-power calculation.

Second angle measurer 213 of qth radar section 10 uses, instead of the output of second demultiplexer 211, the output from BMS-configuration demultiplexer 403. Second angle measurer 213 of qth radar section 10 performs the angle measurement of the target object based on, for example, information input from BMS-configuration demultiplexer 403 for each predetermined period (for example, outputs (for example, P_{RFT}(f_{b}^{BMS}, m₁), and the like) from BMS-configuration reception-power calculator 401, which is a local peak signal, and the BF response (for example, RFT_{z,q}(f_{b}^{BMS}, m₁), and the like) used for the BMS-configuration reception-power calculation). For example, second angle measurer 213 may perform angle measurement based on a reflected wave signal of TxSig from qeth radar section 10, which is demultiplexed in BMS-configuration demultiplexer 403.

For example, in a case where DDM multiplexing is used, since second angle measurer 213 of qth radar section 10 performs the angle measurement processing using the BF response, it is difficult to perform DDM demultiplexing. Since it is difficult to detect the direction of departure, second angle measurer 213 of qth radar section 10 may use the BF response and output the BF response as the angle measurement value (for example, the positioning output) in the reception azimuth direction, to integrator 30. The reception azimuth direction obtained using the BF response utilizes the fact that the BF response used for the BMS-configuration reception-power calculation, for example, RFT_{z,q}(f_{b}^{BMS}, m₁), has a phase different for each reception antenna depending on the arrival direction of a target-object reflection wave, which is a reception signal. For example, the angle measurement with a BMS configuration as described in Non-Patent Literature 5 or 6 may be used.

Further, for example, in a case where TDM multiplexing is used instead of DDM multiplexing, the transmission antenna is switched in time division, and thus, second angle measurer 213 of qth radar section 10 can perform the angle measurement processing using the BF response, and may output the angle measurement value (for example, the positioning output) to integrator 30 including the direction of departure. The direction of departure obtained using the BF response utilizes the fact that the BF response used for the BMS-configuration reception-power calculation, for example, RFT_{z,q}(f_{b}^{BMS}, m₁), has a phase different for each transmission antenna depending on the departure direction of a target-object reflection wave, which is a reception signal. For example, the angle measurement with a BMS configuration as described in Non-Patent Literature 5 or 6 may be used.

In the above-described operation, second angle measurer 213 of qth radar section 10 may output, for example, f_{b}^{BMS}, the reception azimuth angle measurement value and the direction-of-departure angle measurement value (in the case of TDM multiplexing transmission) for f_{b}^{BMS} as a positioning output, and output the outputs (for example, P_{RFT}(f_{b}^{BMS}, m₁) or P_{RFT}(f_{b}^{BMS}, m₁, m₂)) from BMS-configuration reception-power calculator 401, which are the local peak signals as an angle measurement value (for example, positioning output), to integrator 30.

Distance corrector 301 of integrator 30 receives, as inputs, the positioning output (f_{bp}^{BMS}, which is an R-Index output in the BMS configuration, will be referred to as f_{bp}^{BMS}(1) hereinafter) of second angle measurer 213 from first radar section 10 and the positioning output (f_{bp}^{BMS}, which is an R-Index output in the BMS configuration, will be referred to as f_{bp}^{BMS}(2) hereinafter) of second angle measurer 213 from second radar section 10. Distance corrector 301 performs the distance correction processing in the BMS configuration described below for each input information for each predetermined period from second angle measurer 213 of each radar section 10.

Distance corrector 301 assumes that the transmission timing error (including a frequency error) between first radar section 10 and second radar section 10 varies within Nc times of transmission periods Tr and processes distance errors due to the transmission timing errors as described later, at a minimum cycle or a cycle that is integer multiple thereof, at which distance demultiplexing of the reception signal from each radar section 10 with the BMS configuration is performed and the reception signal is output.

For example, as shown in FIG. 4, controller 104 alternately configures a transmission period including predetermined transmission delay Td and a transmission period not including transmission delay Td in a plurality of transmission periods in which the first radar transmission signal and the second radar transmission signal are transmitted, and performs a configuration in which the transmission periods including transmission delay Td are not matched between first radar section 10 and second radar section 10 in the BMS configuration. Thus, beat analyzer 208 obtains an output in which the reception signals from each radar section 10, which has a BMS configuration, are subjected to distance demultiplexing at a cycle of N_{sw}Tr. By performing control of such a transmission signal, distance corrector 301 can correct a distance error due to a transmission timing error at a cycle of N_{sw}Tr or a cycle of an integer multiple of N_{sw}Tr.

For this reason, in a case where the variation in the transmission timing error (including a frequency error) is large, the operation cycle of the distance error correction in distance corrector 301 may be configured as, for example, a cycle of N_{sw}Tr. Further, in a case where the variation in the transmission timing error (including a frequency error) is relatively gentle, the operation cycle of the distance error correction in distance corrector 301 may be set to, for example, an interval of an integer multiple of the cycle of N_{sw}Tr. The operation cycle of the distance error correction in distance corrector 301 can be appropriately set according to the variation situation of the transmission timing error (including a frequency error).

Further, in a case where the number of chirp transmission times in radar apparatus 1 is at least N_{sw}×Tr, the effects described above are obtained. For example, in a case where N_{c}≥N_{sw}×Tr, the distance error due to the transmission timing error can be corrected in a cycle that is an integer multiple of the cycle of N_{sw}Tr.

Note that, here, the directionalities of transmission antenna 102 and reception antenna 202 of each radar section 10 may be the same. In this case, since transmission from first radar section 10 and transmission from second radar section 10 are performed simultaneously, the distance response obtained with the BMS configuration in which first radar section 10 performs transmission and second radar section 10 performs reception and the distance response obtained with the BMS configuration in which second radar section 10 performs transmission and first radar section 10 performs reception are assumed to be substantially the same distance response.

For each input information for each predetermined cycle from second angle measurer 213 of each radar section 10, distance corrector 301 averages distances between f_{bp}^{BMS}(1) and f_{bp}^{BMS}(2) which are R-Index outputs in the BMS configuration, and outputs the distance information in which the distance error is corrected. For example, distance corrector 301 may output (R(f_{bp}^{BMS}(1))+R(f_{bp}^{BMS}(2)))/2 or a distance error estimation value (for example, (R(f_{bp}^{BMS}(1))−R(f_{bp}^{BMS}(2)))/2 or (R(f_{bp}^{BMS}(2)−R(f_{bp}^{BMS}(1)))/2) corresponding to C₀ΔTx.

Note that, in a case where each of R-Index, which a distance response obtained in the BMS configuration in which transmission is performed from first radar section 10 and reception is performed by second radar section 10 and R-Index, which a distance response obtained in the BMS configuration in which transmission is performed from second radar section 10 and reception is performed by first radar section 10 is output multiple times, relative distance relationships between this plurality of reception signals are the same relationships (since a constant distance error is included in the plurality of reception signals, the relationship is a relationship in which the R-Indices match when shifted (caused to be offset) by a specific number of Indices (ΔN_{index}) in the R-Index direction). For this reason, a pair of R-Indices for distance correction between BMSs can be extracted, and distance corrector 301 can perform the distance correction even in a case where a plurality of R-Index outputs are included. Further, the above-described ΔN_{index} represents a distance error estimation value corresponding to C₀ΔTx, and distance corrector 301 may output, for example, the distance error estimation value as R(ΔN_{index}/2). Further, distance corrector 301 may output distance information in which a distance error is corrected using the distance error estimation value, for each predetermined period from second angle measurer 213 of each radar section 10.

The distance correction in distance corrector 301 described above makes it possible to reduce an error in the detected distance in a BMS configuration even in a case where the transmission timing error (including a frequency error) between first radar section 10 and second radar section 10 varies within Nc times of transmission periods Tr. Further, in integrator 30, the positioning processing in the BMS configuration may be performed by using the output in which distance correction is performed in the BMS configuration by distance corrector 301 and the outputs from second angle measurer 213 from each radar section 10, and thus, it is possible to prevent the radar positioning performance from deteriorating.

In addition, radar apparatus 1 can receive a reception signal of a reflection wave in the MNS configuration and a reception signal of a reflection wave in the BMS configuration by demultiplexing the reception signals, thus maintaining the radar detection performance (for example, the detectable Doppler detection range) in the MNS configuration, enabling inter-BMS simultaneous multiplexing transmission in addition to the simultaneous multiplexing transmission in the MNS configuration, and achieving a time-saving effect required for radar distance measurement. Therefore, according to the present embodiment, the target object can be efficiently detected in radar apparatus 1a.

Note that, in the present embodiment, the exemplary operation is described by using an example (for example, the example shown in FIG. 4) in which controller 104 configures the transmission periods including predetermined transmission delay Td and the transmission period not including transmission delay Td alternately and such that the transmission periods including predetermined transmission delay Td do not match between first radar section 10 and second radar section 10, and these transmission periods are repeated in the transmission period of 2Tr, but the present disclosure is not limited to such a configuration. Controller 104 performs configuration such that in a certain transmission period among transmission periods N_{sw}×Tr in which the transmission timing is repeated in a predetermined pattern, transmission delay Td is included for first radar section 10, transmission delay Td is not included for second radar section 10, and in another transmission period, transmission delay Td is not included for first radar section 10, and transmission delay Td is included for second radar section 10. Thus, the effects in the present embodiment are obtained. For example, radar apparatus 1a is capable of receiving a reception signal of a reflection wave in an MNS configuration and a reception signal of a reflection wave in a BMS configuration in a demultiplexing manner, and the error of the detected distance in a BMS configuration can be reduced even in a case where the transmission timing error (including a frequency error) between first radar section 10 and second radar section 10 varies within Nc times of transmission periods Tr due to the distance correction in distance corrector.

Further, in radar apparatus 1a, each transmission period among N_{c} times of transmission periods Tᵣ is referred to by an index “m.” Here, m is an integer of 1 to N_{c}. Further, N_{c}≥N_{sw}×Tr.

### (Variation 2)

The above embodiment has been described with respect to the BMS configuration of first radar section 10 and second radar section 10, but the present disclosure is not limited thereto. For example, two or more radar sections 10 may be used in the BMS configuration, and the same advantages as those of the above-described embodiment can be obtained. For example, two or more radar sections 10 may be used similarly for Variation 1, and effects similar to those of the variation can be obtained.

For example, in a case where three radar sections 10 are used to be applied to the above-described embodiment, the following operations of controller 104 may be performed, when a BMS configuration by first radar section 10 and second radar section 10 and a BMS configuration by second radar section 10 and third radar section 10 are applied to the above-described embodiment in addition to the MNS configurations of first radar section 10, second radar section 10, and third radar section 10. By performing the same operations as those in the above-described embodiments with respect to the MNS configurations of first radar section 10, second radar section 10, and third radar section 10, the BMS configuration of first radar section 10 and second radar section 10, and the BMS configuration of second radar section 10 and third radar section 10, the same effects are obtained for each of the MNS configuration and the BMS configuration.

Controller 104 may perform a configuration such that, in a certain transmission period among transmission periods N_{sw}×Tr in which a transmission timing is repeated in a predetermined pattern, transmission delay Td is included in the transmission chirp signal of first radar section 10, and transmission delay Td is not included in the transmission chirp signal of second radar section 10, and in another transmission period, transmission delay Td is not included in the transmission chirp signal of first radar section 10, and transmission delay Td is included in the transmission chirp signal of second radar section 10, and further in yet another transmission period, transmission delay Td is included in the transmission chirp signal of second radar section 10, and transmission delay Td is not included in the transmission chirp signal of third radar section 10, and in still another transmission period, transmission delay Td is not included in the transmission chirp signal of second radar section 10, and transmission delay Td is included in the transmission chirp signal of third radar section 10. Thus, the same effects as those in the above-described embodiments can be obtained in first radar section 10 and second radar section 10. Further, the same effects as those in the above-described embodiments are obtained in second radar section 10 and third radar section 10.

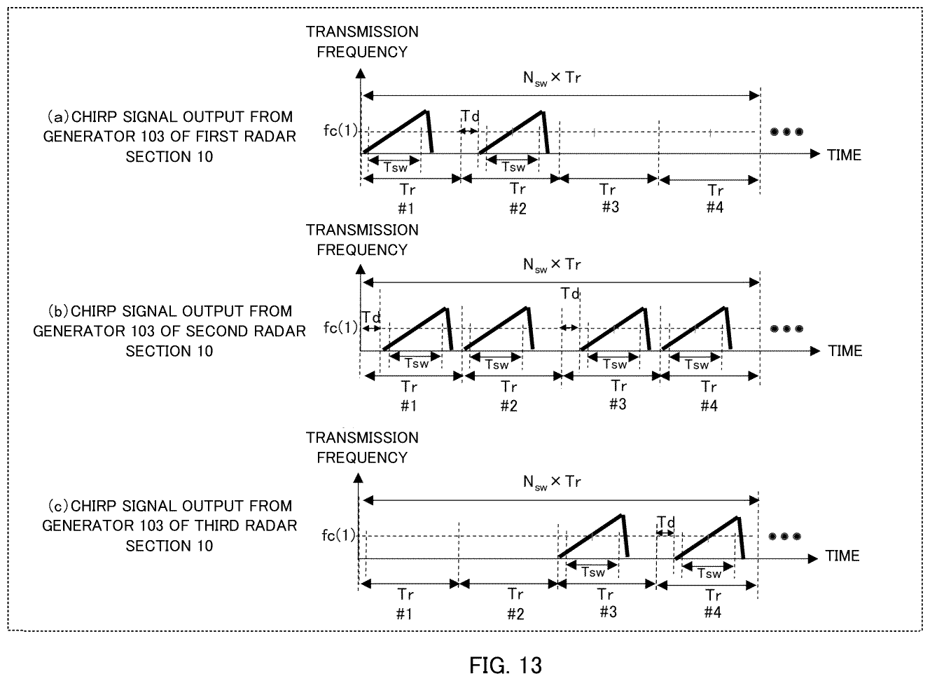

For example, FIG. 13 shows an example, in which in a transmission period m=4j+1 among transmission periods with a length of N_{sw}×Tr=4, transmission delay Td is included in the transmission chirp signal of second radar section 10, and transmission delay Td is not included in the transmission chirp signal of first radar section 10, and in a transmission period m=4j+2, transmission delay Td is not included in the transmission chirp signal of second radar section 10, and transmission delay Td is included in the transmission chirp signal of first radar section 10, and further in a transmission period m=4j+3, transmission delay Td is included in the transmission chirp signal of second radar section 10, and transmission delay Td is not included in the transmission chirp signal of third radar section 10, and in a transmission period m=4 (j+1), transmission delay Td is not included in the transmission chirp signal of second radar section 10, and transmission delay Td is included in the transmission chirp signal of third radar section 10. Here, j=0, 1, . . . , (Nc−1)/4, and m=1 to Nc.

Note that, FIG. 13 shows an example in which third radar section 10 performs transmission suspension of the chirp signal in the transmission periods m=4j+1 and m=4j+2. However, third radar section 10 may perform transmission with the MNS configuration by a transmission frequency (for example, frequency division (FDM) transmission with respect to first radar section 10 and second radar section 10) that does not cause interference to first radar section 10 and second radar section 10. Similarly, an example is shown, in which first radar section 10 performs transmission suspension of the chirp signal in the transmission periods m=4j+3 and m=4 (j+1). However, first radar section 10 may perform transmission with the MNS configuration by a transmission frequency (for example, frequency division (FDM) transmission with respect to first radar section 10 and second radar section 10) that does not cause interference to second radar section 10 and third radar section 10.

### (Variation 3)

In the above-described embodiment, the case where each radar section 10 generates a chirp signal individually based on the reference signal input from synchronizer 20 has been described, but an example according to the present disclosure can also be applied to a case where common chirp signals are generated in synchronizer 20 to be set as an output of generator 103 in each radar section 10. In this case, the chirp signals used in each radar section become signals subjected to phase synchronization, and thus, the application of Embodiment 1 can be achieved and a similar effect is obtained.

### (Variation 4)

In the above-described embodiments, a case where processing in the MNS configuration and processing in the BMS configuration are performed cyclically (or regularly) in each transmission period has been described, but the present disclosure is not limited thereto. For example, a transmission period in which processing in the BMS configuration (for example, simultaneous transmission from each radar section 10) is performed (for example, a transmission period in which transmission delay Td is set) may be configured as a non-cyclic (or non-regular) part of the plurality of transmission periods in which radar apparatus 1 transmits a transmission signal. For example, the transmission period for performing transmission processing in the BMS configuration may be configured (for example, limited) as another transmission period (for example, the transmission period after the positioning in the MNS configuration) different from the transmission period in which the transmission processing in the MNS configuration is performed. Thus, radar apparatus 1 makes it possible to detect a target object with the BMS configuration in, for example, a part of the transmission periods (short sections for transmitting, for example, approximately 2 to 4 chirp signals).

### (Variation 5)

In radar apparatus 1, first radar section 10 and second radar section 10 may perform transmission processing (for example, simultaneous transmission of a first transmission signal and a second transmission signal) in a BMS configuration in a case where a target object is present within a predetermined range from radar apparatus 1, and may not perform the transmission processing in the BMS configuration in a case where the target is not present within the predetermined range.

The transmission period (for example, the transmission period in which transmission delay Td is set) in which the processing in the BMS configuration is performed may be configured in a case where a target object is present within a predetermined range from radar apparatus 1, and may not be set in a case where a target is not present within the predetermined range from radar apparatus 1.

### (Variation 6)

The frequency bands of the first transmission signal and the second transmission signal in a transmission period (for example, a transmission period in which transmission delay Td is set) for performing transmission processing (for example, simultaneous transmission of the first transmission signal from first radar section 10 and the second transmission signal from second radar section 10) in the BMS configuration may be set narrower than the frequency bands of the transmission signals in another transmission period in which the transmission processing in the BMS configuration is not performed.

Further, for example, the transmission time (for example, pulse repetition interval (PRI)) of the first transmission signal and the second transmission signal in a transmission period (for example, a transmission period in which transmission delay Td is set) in which the transmission processing (for example, simultaneous transmission of the first transmission signal from first radar section 10 and the second transmission signal from second radar section 10) in the BMS configuration is performed may be set longer than the transmission time of the transmission signal in another transmission period in which the transmission processing in the BMS configuration is not performed.

Thus, for example, even in a case where the frequency error (or the transmission timing error) is large, radar apparatus 1 can detect a target object in a BMS configuration.

### (Variation 7)

In the above-described embodiment, a case where DDM multiplexing is performed in the MNS configuration has been described, but the multiplexing method is not limited to DDM multiplexing, and may be another multiplexing method (for example, TDM multiplexing).

One exemplary embodiment of the present disclosure has been described above.

### OTHER EMBODIMENTS

Regarding the above-described embodiments, the configuration has been described in which the chirp signals are used as TxSig, but TxSig may be signals differing from the chirp signals. For example, the TxSig may be a pulse compression wave, such as a coded pulse signal. When the coded pulse signal is used for TxSig, mixer 204 of reception radio 203 converts a high-frequency reception signal into a baseband signal, and a correlator (not illustrated) that correlates the high-frequency reception signal with the coded pulse signal transmitted is used instead of beat analyzer 208. Accordingly, the subsequent processing can be performed in the same manner as the processing according to each of the above-described embodiments, and the same effects can be obtained.

In the radar apparatus according to one exemplary embodiment of the present disclosure, the transmitter and the receiver may be individually arranged in physically separate locations from each other. In the receiver according to one exemplary embodiment of the present disclosure, the angle measurer and any other component may be individually arranged in physically separate locations.

Further, in one exemplary embodiment of the present disclosure, the numerical values used for parameters such as the number of transmission antennas, the number of reception antennas, the number of DDM, the number of radar sections, the DDM interval, the parameter related to the DDM interval (for example, δ_{q}), the parameters (e.g., N_{sw}) related to the transmission period, and transmission delay are examples, and are not limited to these values.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples.

Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “device,” “unit,” or “module”.

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit or a general-purpose processor and a memory. In addition, a Field Programmable Gate Array (FPGA) that can be programmed after the manufacture of the LSI or a reconfigurable processor in which the connections and the configurations of circuit cells disposed inside the LSI can be reconfigured may be used.

If future integrated circuit technology replaces LSIs as a result of the advancement of semiconductor technology or other derivative technology, the functional blocks could be integrated using the future integrated circuit technology. Biotechnology can also be applied.

### SUMMARY OF PRESENT DISCLOSURE

A radar apparatus according to one non-limiting and exemplary embodiment of the present disclosure includes: first radar circuitry, which, in operation, transmits a first transmission signal; and second radar circuitry, which, in operation, transmits a second transmission signal; in which a plurality of transmission periods in which the first transmission signal and the second transmission signal are transmitted include a first transmission period in which a transmission timing for the first transmission signal is later than a transmission timing for the second transmission signal by a defined value, and a second transmission period in which the transmission timing for the second transmission signal is later than the transmission timing for the first transmission signal by the defined value.

In the radar apparatus according to one non-limiting and exemplary embodiment of the present disclosure, the first transmission period and the second transmission period are alternately configured in the plurality of transmission periods.

In the radar apparatus according to one non-limiting and exemplary embodiment of the present disclosure, the first radar circuitry is configured to: demultiplex a first reflected wave signal corresponding to the first transmission signal and a second reflected wave signal corresponding to the second transmission signal from a Doppler frequency component of a reception signal in the first transmission period, and demultiplex a third reflected wave signal corresponding to the first transmission signal and a fourth reflected wave signal corresponding to the second transmission signal from a Doppler frequency component of a reception signal in the second transmission period, based on the first reflected wave signal.

In the radar apparatus according to one non-limiting and exemplary embodiment of the present disclosure, the second radar circuitry is configured to: demultiplex a first reflected wave signal corresponding to the second transmission signal and a second reflected wave signal corresponding to the first transmission signal from a Doppler frequency component of a reception signal in the second transmission period, and demultiplex a third reflected wave signal corresponding to the second transmission signal and a fourth reflected wave signal corresponding to the first transmission signal from a Doppler frequency component of a reception signal in the first transmission period, based on the first reflected wave signal.

In the radar apparatus according to one non-limiting and exemplary embodiment of the present disclosure, the first radar circuitry demultiplexes a reflected wave signal corresponding to the second transmission signal from a range component of a reception signal in the first transmission period.

In the radar apparatus according to one non-limiting and exemplary embodiment of the present disclosure, the second radar circuitry demultiplexes a reflected wave signal corresponding to the first transmission signal from a range component of a reception signal in the second transmission period.

The radar apparatus according to one non-limiting and exemplary embodiment of the present disclosure further includes: correction circuitry, which, in operation, corrects a distance to a target object based on an average value of a distance calculated based on a range component of a reflected wave signal corresponding to the second transmission signal in the first radar circuitry and a distance calculated based on a range component of a reflected wave signal corresponding to the first transmission signal in the second radar circuitry.

In the radar apparatus according to one non-limiting and exemplary embodiment of the present disclosure, the first radar circuitry transmits the first transmission signal from a plurality of first transmission antennas, the second radar circuitry transmits the second transmission signal from a plurality of second transmission antennas, and an interval between Doppler shift amounts applied to a plurality of the first transmission signals transmitted respectively from the plurality of first transmission antennas and an interval between Doppler shift amounts applied to a plurality of the second transmission signals transmitted respectively from the plurality of second transmission antennas are different from each other.

In the radar apparatus according to one non-limiting and exemplary embodiment of the present disclosure, in the first transmission period, the first radar circuitry transmits the first transmission signal to which a different Doppler shift amount is applied, from each of a plurality of first transmission antennas, and the second radar circuitry transmits the second transmission signal from one second transmission antenna, and in the second transmission period, the first radar circuitry transmits the first transmission signal from one of the plurality of first transmission antennas, and the second radar circuitry transmits the second transmission signal to which a different Doppler shift amount is applied, from each of a plurality of the second transmission antennas.

In the radar apparatus according to one non-limiting and exemplary embodiment of the present disclosure, in the first transmission period, the first radar circuitry transmits the first transmission signal from one first transmission antenna and the second radar circuitry transmits the second transmission signal to which a different Doppler shift amount is applied, from each of a plurality of second transmission antennas, and in the second transmission period, the first radar circuitry transmits the first transmission signal to which a different Doppler shift amount is applied, from each of a plurality of the first transmission antennas, and the second radar circuitry transmits the second transmission signal from one of the plurality of second transmission antennas.

In the radar apparatus according to one non-limiting and exemplary embodiment of the present disclosure, the first transmission period and the second transmission period are set to a non-cyclic part of the plurality of transmission periods in which the radar apparatus transmits a transmission signal.

In the radar apparatus according to one non-limiting and exemplary embodiment of the present disclosure, the first transmission period and the second transmission period are set in a case where a target object is present within a predetermined range from the radar apparatus, and are not set in a case where the target object is not present within the predetermined range.

In the radar apparatus according to one non-limiting and exemplary embodiment of the present disclosure, a frequency band of the first transmission signal and the second transmission signal in the first transmission period and the second transmission period is narrower than a frequency band of a transmission signal in another transmission period different from the first transmission period and the second transmission period.

In the radar apparatus according to one non-limiting and exemplary embodiment of the present disclosure, a transmission time of the first transmission signal and the second transmission signal in the first transmission period and the second transmission period is longer than a transmission time of a transmission signal in another transmission period different from the first transmission period and the second transmission period.

A transmission method for a radar apparatus according to one non-limiting and exemplary embodiment of the present disclosure includes: transmitting a first transmission signal by first radar circuitry of a radar apparatus; and transmitting a second transmission signal by second radar circuitry of the radar apparatus, in which a plurality of transmission periods in which the first transmission signal and the second transmission signal are transmitted include a first transmission period in which a transmission timing for the first transmission signal is later than a transmission timing for the second transmission signal by a defined value, and a second transmission period in which the transmission timing for the second transmission signal is later than the transmission timing for the first transmission signal by the defined value.

In the transmission method for a radar apparatus according to one non-limiting and exemplary embodiment of the present disclosure, the first transmission period and the second transmission period are alternately configured in the plurality of transmission periods.

In the transmission method for a radar apparatus according to one non-limiting and exemplary embodiment of the present disclosure, by the first radar circuitry, a first reflected wave signal corresponding to the first transmission signal and a second reflected wave signal corresponding to the second transmission signal are demultiplexed from a Doppler frequency component of a reception signal in the first transmission period, and a third reflected wave signal corresponding to the first transmission signal and a fourth reflected wave signal corresponding to the second transmission signal are demultiplexed based on the first reflected wave signal from a Doppler frequency component of a reception signal in the second transmission period.

In the transmission method for a radar apparatus according to one non-limiting and exemplary embodiment of the present disclosure, by the second radar circuitry, a first reflected wave signal corresponding to the second transmission signal and a second reflected wave signal corresponding to the first transmission signal are demultiplexed from a Doppler frequency component of a reception signal in the second transmission period, and a third reflected wave signal corresponding to the second transmission signal and a fourth reflected wave signal corresponding to the first transmission signal are demultiplexed based on the first reflected wave signal from a Doppler frequency component of a reception signal in the first transmission period.

In the transmission method for a radar apparatus according to one non-limiting and exemplary embodiment of the present disclosure, by the first radar circuitry, a reflected wave signal corresponding to the second transmission signal is demultiplexed from a range component of a reception signal in the first transmission period.

In the transmission method for a radar apparatus according to one non-limiting and exemplary embodiment of the present disclosure, by the second radar circuitry, a reflected wave signal corresponding to the first transmission signal is demultiplexed from a range component of a reception signal in the second transmission period.

While various embodiments have been described herein above, it is to be appreciated that various changes in form and detail may be made without departing from the sprit and scope of the disclosure(s) presently or hereafter claimed.

This application is entitled and claims the benefit of Japanese Patent Application No. 2023-223110, filed on Dec. 28, 2023, the disclosure of which including the specification, drawings and abstract is incorporated herein by reference in its entirety.

### INDUSTRIAL APPLICABILITY

The present disclosure is suitable as a radar apparatus for wide-angle range sensing.

### REFERENCE SIGNS LIST

1, 1a Radar apparatus
10 Radar section
20 Synchronizer
30 Integrator
100 Transmitter
101 Doppler shift section
102 Transmission antenna
103 Generator
104 Controller
105 Modulation signal generator
106 VCO
200, 200a Receiver
201 System processor
202 Reception antenna
203 Reception radio
204 Mixer
205 LPF
206 Analyzer
207 A/D converter
208 Beat analyzer
209 Doppler analysis section
210 CFAR section
211 Demultiplexer
212 Determiner
213 Angle measurer
301 Distance corrector
401 BMS-configuration reception-power calculator
402 BMS configuration CFAR section
403 BMS-configuration demultiplexer

1. A radar apparatus, comprising:
first radar circuitry, which, in operation, transmits a first transmission signal; and
second radar circuitry, which, in operation, transmits a second transmission signal; wherein
a plurality of transmission periods in which the first transmission signal and the second transmission signal are transmitted include a first transmission period in which a transmission timing for the first transmission signal is later than a transmission timing for the second transmission signal by a defined value, and a second transmission period in which the transmission timing for the second transmission signal is later than the transmission timing for the first transmission signal by the defined value.

2. The radar apparatus according to claim 1, wherein
the first transmission period and the second transmission period are alternately configured in the plurality of transmission periods.

3. The radar apparatus according to claim 1, wherein
the first radar circuitry, which, in operation,
demultiplexes a first reflected wave signal corresponding to the first transmission signal and a second reflected wave signal corresponding to the second transmission signal from a Doppler frequency component of a reception signal in the first transmission period, and
demultiplexes a third reflected wave signal corresponding to the first transmission signal and a fourth reflected wave signal corresponding to the second transmission signal from a Doppler frequency component of a reception signal in the second transmission period, based on the first reflected wave signal.

4. The radar apparatus according to claim 1, wherein
the second radar circuitry, which, in operation,
demultiplexes a first reflected wave signal corresponding to the second transmission signal and a second reflected wave signal corresponding to the first transmission signal from a Doppler frequency component of a reception signal in the second transmission period, and
demultiplexes a third reflected wave signal corresponding to the second transmission signal and a fourth reflected wave signal corresponding to the first transmission signal from a Doppler frequency component of a reception signal in the first transmission period, based on the first reflected wave signal.

5. The radar apparatus according to claim 1, wherein
the first radar circuitry demultiplexes a reflected wave signal corresponding to the second transmission signal from a range component of a reception signal in the first transmission period.

6. The radar apparatus according to claim 1, wherein
the second radar circuitry demultiplexes a reflected wave signal corresponding to the first transmission signal from a range component of a reception signal in the second transmission period.

7. The radar apparatus according to claim 1, further comprising:
correction circuitry, which, in operation, corrects a distance to a target object based on an average value of a distance calculated based on a range component of a reflected wave signal corresponding to the second transmission signal in the first radar circuitry and a distance calculated based on a range component of a reflected wave signal corresponding to the first transmission signal in the second radar circuitry.

8. The radar apparatus according to claim 1, wherein:
the first radar circuitry transmits the first transmission signal from a plurality of first transmission antennas,
the second radar circuitry transmits the second transmission signal from a plurality of second transmission antennas, and
an interval between Doppler shift amounts applied to a plurality of the first transmission signals transmitted respectively from the plurality of first transmission antennas and an interval between Doppler shift amounts applied to a plurality of the second transmission signals transmitted respectively from the plurality of second transmission antennas are different from each other.

9. The radar apparatus according to claim 1, wherein:
in the first transmission period, the first radar circuitry transmits the first transmission signal to which a different Doppler shift amount is applied, from each of a plurality of first transmission antennas, and the second radar circuitry transmits the second transmission signal from one second transmission antenna, and
in the second transmission period, the first radar circuitry transmits the first transmission signal from one of the plurality of first transmission antennas, and the second radar circuitry transmits the second transmission signal to which a different Doppler shift amount is applied, from each of a plurality of the second transmission antennas.

10. The radar apparatus according to claim 1, wherein:
in the first transmission period, the first radar circuitry transmits the first transmission signal from one first transmission antenna and the second radar circuitry transmits the second transmission signal to which a different Doppler shift amount is applied, from each of a plurality of second transmission antennas, and
in the second transmission period, the first radar circuitry transmits the first transmission signal to which a different Doppler shift amount is applied, from each of a plurality of the first transmission antennas, and the second radar circuitry transmits the second transmission signal from one of the plurality of second transmission antennas.

11. The radar apparatus according to claim 1, wherein
the first transmission period and the second transmission period are set to a non-cyclic part of the plurality of transmission periods in which the radar apparatus transmits a transmission signal.

12. The radar apparatus according to claim 1, wherein
the first transmission period and the second transmission period are set in a case where a target object is present within a predetermined range from the radar apparatus, and are not set in a case where the target object is not present within the predetermined range.

13. The radar apparatus according to claim 1, wherein
a frequency band of the first transmission signal and the second transmission signal in the first transmission period and the second transmission period is narrower than a frequency band of a transmission signal in another transmission period different from the first transmission period and the second transmission period.

14. The radar apparatus according to claim 1, wherein
a transmission time of the first transmission signal and the second transmission signal in the first transmission period and the second transmission period is longer than a transmission time of a transmission signal in another transmission period different from the first transmission period and the second transmission period.

15. A transmission method, comprising:
transmitting a first transmission signal by first radar circuitry of a radar apparatus; and
transmitting a second transmission signal by second radar circuitry of the radar apparatus, wherein
a plurality of transmission periods in which the first transmission signal and the second transmission signal are transmitted include a first transmission period in which a transmission timing for the first transmission signal is later than a transmission timing for the second transmission signal by a defined value, and a second transmission period in which the transmission timing for the second transmission signal is later than the transmission timing for the first transmission signal by the defined value.

16. The transmission method according to claim 15, wherein
the first transmission period and the second transmission period are alternately configured in the plurality of transmission periods.

17. The transmission method according to claim 15, wherein
by the first radar circuitry,
a first reflected wave signal corresponding to the first transmission signal and a second reflected wave signal corresponding to the second transmission signal are demultiplexed from a Doppler frequency component of a reception signal in the first transmission period, and
a third reflected wave signal corresponding to the first transmission signal and a fourth reflected wave signal corresponding to the second transmission signal are demultiplexed based on the first reflected wave signal from a Doppler frequency component of a reception signal in the second transmission period.

18. The transmission method according to claim 15, wherein
by the second radar circuitry,
a first reflected wave signal corresponding to the second transmission signal and a second reflected wave signal corresponding to the first transmission signal are demultiplexed from a Doppler frequency component of a reception signal in the second transmission period, and
a third reflected wave signal corresponding to the second transmission signal and a fourth reflected wave signal corresponding to the first transmission signal are demultiplexed based on the first reflected wave signal from a Doppler frequency component of a reception signal in the first transmission period.

19. The transmission method according to claim 15, wherein
by the first radar circuitry, a reflected wave signal corresponding to the second transmission signal is demultiplexed from a range component of a reception signal in the first transmission period.

20. The transmission method according to claim 15, wherein
by the second radar circuitry, a reflected wave signal corresponding to the first transmission signal is demultiplexed from a range component of a reception signal in the second transmission period.
